(19) United States
(12) Patent Application Publication
(10) Pub. No.: US 2026/0068924 A1
(43) Pub. Date: Mar. 12, 2026

(54) AN AEROSOL-GENERATING ARTICLE COMPRISING A HIGH WEIGHT RATIO OF AEROSOL-FORMING SUBSTRATE

(71) Applicant: Philip Morris Products S.A., Neuchatel (CH)

(72) Inventors: Gennaro CAMPITELLI, Basel (CH); Bruno Christian Joseph CHASSOT, Auvernier (CH)

(73) Assignee: Philip Morris Products S.A., Neuchatel (CH)

(21) Appl. No.: 19/109,372

(22) PCT Filed: Sep. 12, 2023
(86) PCT No.: PCT/EP2023/075053

§ 371 Date: Mar. 6, 2025

(30) Foreign Application Priority Data
Sep. 12, 2022 (EP) 22195213.8

(51) Int. Cl. A24D 1/20; A24D 3/17; A24F 40/20; H05B 6/10

(52) U.S. Cl. CPC A24D 1/20; A24D 3/17; A24F 40/20; H05B 6/108

(57) ABSTRACT

An aerosol-generating article is provided, including: an aerosol-forming substrate section containing an aerosol-forming substrate; and a downstream section provided at a downstream end of the aerosol-forming substrate section, the downstream section including one or more hollow tubular elements, the downstream section further including a downstream filter segment, and the downstream section having a length of at least 25 millimetres, a ratio of a weight of the downstream section to a weight of the aerosol-forming substrate being less than or equal to 1.

The present invention relates to an aerosol-generating article comprising an aerosol-forming substrate section comprising an aerosol-forming substrate. A ratio of the weight of the downstream section to the weight of the aerosol-forming substrate is lower than in typical aerosol-generating articles.

Aerosol-generating articles in which an aerosol-forming substrate, such as a tobacco-containing substrate, is heated rather than combusted, are known in the art. Typically, in such heated smoking articles an aerosol nis generated by the transfer of heat from a heat source to a physically separate aerosol-forming substrate or material, which may be located in contact with, within, around, or downstream of the heat source. During use of the aerosol-generating article, volatile compounds are released from the aerosol-forming substrate by heat transfer from the heat source and are entrained in air drawn through the aerosol-generating article. As the released compounds cool, they condense to form an aerosol.

A number of prior art documents disclose aerosol-generating devices for consuming aerosol-generating articles. Such devices include, for example, electrically heated aerosol-generating devices in which an aerosol is generated by the transfer of heat from one or more electrical heater elements of the aerosol-generating device to the aerosol-forming substrate of a heated aerosol-generating article. For example, electrically heated aerosol-generating devices have been proposed that comprise an internal heater blade which is adapted to be inserted into the aerosol-forming substrate (WO 2013/098405). Use of an aerosol-generating article in combination with an external heating system is also known. For example, WO 2020/115151 describes the provision of one or more heating elements arranged around the periphery of the aerosol-generating article when the aerosol-generating article is received in a cavity of the aerosol-generating device. As an alternative, inductively heatable aerosol-generating articles comprising an aerosol-forming substrate and a susceptor arranged within the aerosol-forming substrate have been proposed by WO 2015/176898.

Aerosol-generating articles in which a tobacco-containing substrate is heated rather than combusted present a number of challenges that were not encountered with conventional smoking articles.

For example, with some aerosol-forming substrates, it can be difficult to deliver sufficient aerosol to a user.

It would be desirable to provide a new and improved aerosol-generating article.

There is provided an aerosol-generating article. The aerosol-generating article may comprise an aerosol-forming substrate section containing an aerosol-forming substrate. The aerosol-generating article may comprise a downstream section provided at a downstream end of the aerosol-forming substrate section. The downstream section may comprise one or more hollow tubular elements. The downstream section may have a length of at least 25 millimetres. A ratio of the weight of the downstream section to the weight of the aerosol-forming substrate may be less than or equal to 1.

There is also provided an aerosol-generating article comprising: an aerosol-forming substrate section containing an aerosol-forming substrate; and a downstream section provided at a downstream end of the aerosol-forming substrate section, the downstream section comprising one or more hollow tubular elements, the downstream section having a length of at least 25 millimetres, wherein a ratio of the weight of the downstream section to the weight of the aerosol-forming substrate is less than or equal to 1.

There is also provided an aerosol-generating article. The aerosol-generating article may comprise an aerosol-forming substrate section containing an aerosol-forming substrate. The aerosol-generating article may comprise a downstream section provided at a downstream end of the aerosol-forming substrate section. The downstream section may comprise one or more hollow tubular elements. The downstream section may have a length of at least 25 millimetres. A ratio of the weight of the downstream section to the weight of the aerosol-generating article may be at less than or equal to 0.5.

There is also provided an aerosol-generating article comprising: an aerosol-forming substrate section containing an aerosol-forming substrate; and a downstream section provided at a downstream end of the aerosol-forming substrate section, the downstream section comprising: one or more hollow tubular elements, wherein the downstream section has a length of at least 25 millimetres, and wherein a ratio of the weight of the downstream section to the weight of the aerosol-generating article is less than or equal to 0.5.

There is also provided an aerosol-generating article. The aerosol-generating article may comprise an aerosol-forming substrate section containing an aerosol-forming substrate. The aerosol-generating article may comprise a downstream section provided at a downstream end of the aerosol-forming substrate section. The downstream section may comprise one or more hollow tubular elements. The downstream section may have a length of at least 25 millimetres. A ratio of the weight of the downstream section to the weight of the aerosol-forming substrate may be less than or equal to 1. The aerosol-generating article may comprise an upstream section provided at an upstream end of the aerosol-forming substrate section. The upstream section may comprise an upstream element. The upstream element may have a weight of less than or equal to 70 milligrams.

There is also provided an aerosol-generating article comprising: an aerosol-forming substrate section containing an aerosol-forming substrate; and a downstream section provided at a downstream end of the aerosol-forming substrate section, the downstream section comprising one or more hollow tubular elements, the downstream section having a length of at least 25 millimetres; and an upstream section provided at an upstream end of the aerosol-forming substrate section, the upstream section comprising an upstream element, wherein a ratio of the weight of the downstream section to the weight of the aerosol-forming substrate is less than or equal to 1, and wherein the upstream element has a weight of less than or equal to 70 milligrams.

There is also provided an aerosol-generating article. The aerosol-generating article may comprise an aerosol-forming substrate section containing an aerosol-forming substrate. The aerosol-generating article may comprise a downstream section provided at a downstream end of the aerosol-forming substrate section. The downstream section may comprise one or more hollow tubular elements. The downstream section may have a length of at least 25 millimetres. A ratio of the weight of the downstream section to the weight of the aerosol-forming substrate may be less than or equal to 1. The aerosol-forming substrate may comprise one or more aerosol formers. The aerosol-forming substrate may have an aerosol former content of at least 10 percent by weight, on a dry weight basis.

There is also provided an aerosol-generating article comprising: an aerosol-forming substrate section containing an aerosol-forming substrate, the aerosol-forming substrate comprising one or more aerosol formers; and a downstream section provided at a downstream end of the aerosol-forming substrate section, the downstream section comprising one or more hollow tubular elements, the downstream section having a length of at least 25 millimetres; and an upstream section provided at an upstream end of the aerosol-forming substrate section, the upstream section comprising an upstream element, wherein a ratio of the weight of the downstream section to the weight of the aerosol-forming substrate is less than or equal to 1, and wherein the upstream element has a weight of less than or equal to 70 milligrams, and wherein the aerosol-forming substrate has an aerosol former content of at least 10 percent by weight, on a dry weight basis.

There is also provided an aerosol-generating system. The aerosol-generating system may comprise an aerosol-generating article. The aerosol-generating article may comprise an aerosol-forming substrate section containing an aerosol-forming substrate. The aerosol-generating article may comprise a downstream section provided at a downstream end of the aerosol-forming substrate section. The downstream section may comprise one or more hollow tubular elements. The downstream section may have a length of at least 25 millimetres. A ratio of the weight of the downstream section to the weight of the aerosol-forming substrate may be less than or equal to 1. The aerosol-generating system may comprise an aerosol-generating device. The aerosol-generating device may comprise a heating chamber for receiving the aerosol-generating article. The aerosol-generating system may comprise at least a heating element provided at or about the periphery of the heating chamber.

There is also provided an aerosol-generating system comprising: an aerosol-generating article and an aerosol-generating device, the aerosol-generating article comprising: an aerosol-forming substrate section containing an aerosol-forming substrate; and a downstream section provided at a downstream end of the aerosol-forming substrate section, the downstream section comprising one or more hollow tubular elements, the downstream section having a length of at least 25 millimetres, wherein a ratio of the weight of the downstream section to the weight of the aerosol-forming substrate is less than or equal to 1; and the aerosol-generating device comprising: a heating chamber for receiving the aerosol-generating article; and at least a heating element provided at or about the periphery of the heating chamber.

There is also provided an aerosol-generating system. The aerosol-generating system may comprise an aerosol-generating article. The aerosol-generating article may comprise an aerosol-forming substrate section containing an aerosol-forming substrate. The aerosol-generating article may comprise a downstream section provided at a downstream end of the aerosol-forming substrate section. The downstream section may comprise one or more hollow tubular elements. The downstream section may have a length of at least 25 millimetres. A ratio of the weight of the downstream section to the weight of the aerosol-generating article may be less than or equal to 0.5. The aerosol-generating system may comprise an aerosol-generating device. The aerosol-generating device may comprise a heating chamber for receiving the aerosol-generating article. The aerosol-generating system may comprise at least a heating element provided at or about the periphery of the heating chamber.

There is also provided an aerosol-generating system comprising: an aerosol-generating article and an aerosol-generating device, aerosol-generating article comprising: an aerosol-forming substrate section containing an aerosol-forming substrate; and a downstream section provided at a downstream end of the aerosol-forming substrate section, the downstream section comprising: one or more hollow tubular elements, wherein the downstream section has a length of at least 25 millimetres, and wherein a ratio of the weight of the downstream section to the weight of the aerosol-generating article is less than or equal to 0.5; and the aerosol-generating device comprising: a heating chamber for receiving the aerosol-generating article; and at least a heating element provided at or about the periphery of the heating chamber.

The present inventors have found that providing a ratio of the weight of the downstream section to the weight of the aerosol-forming substrate of less than or equal to 1 may reduce the amount of material in the aerosol-generating article that is not a part of the aerosol-forming substrate. Reducing the amount of material that is not the aerosol-forming substrate may reduce that risk that aerosol generated through aerosolization of the aerosol-forming substrate is filtered and retained by the components of the aerosol-generating article that are not the aerosol-forming substrate. For example, in some aerosol-generating articles, aerosol that is generated may be filtered by a part of the downstream section. Filtering of aerosol that is generated may reduce the amount of aerosol that can be delivered to a user.

Consequently, reducing unwanted filtration by components of the aerosol-generating article may allow for a higher delivery of aerosol to a user, and may provide for a longer user experience.

Furthermore, providing a ratio of the weight of the downstream section to the weight of the aerosol-forming substrate of less than or equal to 1 may provide for an increased weight of the aerosol-forming substate. Increasing the weight of the aerosol-forming substrate may also allow for a higher delivery of aerosol to a user and may provide for a longer user experience.

In one example, the ratio of the weight of the downstream section to the weight of the aerosol-forming substrate being less than or equal to 1 may be provided by increasing the length of the aerosol-forming substrate section.

In another example, the ratio of the weight of the downstream section to the weight of the aerosol-forming substrate being less than or equal to 1 may be provided by decreasing the length of the downstream section.

In another example, the ratio of the weight of the downstream section to the weight of the aerosol-forming substrate being less than or equal to 1 may be provided by increasing the density of the aerosol-forming substrate.

Unless otherwise specified, the resistance to draw (RTD) of a component or the aerosol-generating article is measured in accordance with ISO 6565-2015. The RTD refers the pressure required to force air through the full length of a component. The terms “pressure drop” or “draw resistance” of a component or article may also refer to the “resistance to draw”. Such terms generally refer to the measurements in accordance with ISO 6565-2015 are normally carried out at under test at a volumetric flow rate of 17.5 millilitres per second at the output or downstream end of the measured component at a temperature of 22 degrees Celsius, a pressure of 101 kPa (about 760 Torr) and a relative humidity of 60%. Conditions for smoking and smoking machine specifications are set out in ISO Standard 3308 (ISO 3308:2000). Atmosphere for conditioning and testing are set out in ISO Standard 3402 (ISO 3402:1999).

As used herein, the term “downstream section” refers to all components of the aerosol-generating article that are downstream of the aerosol-forming substrate section.

As used herein, the term “upstream section” refers to all components of the aerosol-generating article that are upstream of the aerosol-forming substrate section.

The aerosol-generating article may have a length of less than or equal to 80 millimetres. The aerosol-generating article may have a length of less than or equal to 70 millimetres. The aerosol-generating article may have a length of less than or equal to 65 millimetres. The aerosol-generating article may have a length of less than or equal to 60 millimetres. The aerosol-generating article may have a length of less than or equal to 55 millimetres. The aerosol-generating article may have a length of less than or equal to 50 millimetres.

The aerosol-generating article may have a length of at least 5 millimetres. The aerosol-generating article may have a length of at least 15 millimetres. The aerosol-generating article may have a length of at least 25 millimetres. The aerosol-generating article may have a length of at least 35 millimetres. The aerosol-generating article may have a length of at least 45 millimetres. The aerosol-generating article may have a length of at least 50 millimetres. The aerosol-generating article may have a length of at least 55 millimetres. The aerosol-generating article may have a length of at least 60 millimetres. The aerosol-generating article may have a length of at least 65 millimetres.

The aerosol-generating article may have a length of between 5 millimetres and 80 millimetres. The aerosol-generating article may have a length of between 15 millimetres and 80 millimetres. The aerosol-generating article may have a length of between 25 millimetres and 80 millimetres. The aerosol-generating article may have a length of between 35 millimetres and 80 millimetres. The aerosol-generating article may have a length of between 35 millimetres and 70 millimetres. The aerosol-generating article may have a length of between 35 millimetres and 65 millimetres. The aerosol-generating article may have a length of between 35 millimetres and 55 millimetres. The aerosol-generating article may have a length of between 35 millimetres and 50 millimetres. The aerosol-generating article may have a length of between 40 millimetres and 50 millimetres.

Advantageously, decreasing the length of the aerosol-generating article may decrease the weight of components of the aerosol-generating article that are not the aerosol-forming substrate. Therefore, decreasing the length of the aerosol-generating article may decrease the ratio of the weight of the downstream section to the weight of the aerosol-forming substrate.

The aerosol-generating article may have a resistance to draw (RTD) of at least 18 mm H₂O. The aerosol-generating article may have a resistance to draw (RTD) of at least 20 mm H₂O. The aerosol-generating article may have a resistance to draw (RTD) of at least 25 mm H₂O. The aerosol-generating article may have a resistance to draw (RTD) of at least 30 mm H₂O. The aerosol-generating article may have a resistance to draw (RTD) of at least 35 mm H₂O. The aerosol-generating article may have a resistance to draw (RTD) of at least 40 mm H₂O. The aerosol-generating article may have a resistance to draw (RTD) of at least 45 mm H₂O.

The aerosol-generating article may have a resistance to draw (RTD) of less than or equal to 24 mm H₂O. The aerosol-generating article may have a resistance to draw (RTD) of less than or equal to 22 mm H₂O. The aerosol-generating article may have a resistance to draw (RTD) of less than or equal to 25 mm H₂O. The aerosol-generating article may have a resistance to draw (RTD) of less than or equal to 30 mm H₂O. The aerosol-generating article may have a resistance to draw (RTD) of less than or equal to 35 mm H₂O. The aerosol-generating article may have a resistance to draw (RTD) of less than or equal to 40 mm H₂O. The aerosol-generating article may have a resistance to draw (RTD) of less than or equal to 45 mm H₂O. The aerosol-generating article may have a resistance to draw (RTD) of less than or equal to 50 mm H₂O. The aerosol-generating article may have a resistance to draw (RTD) of less than or equal to 55 mm H₂O.

The aerosol-generating article may have a resistance to draw (RTD) of between 18 mm H₂O and 24 mm H₂O. The aerosol-generating article may have a resistance to draw (RTD) of between 20 mm H₂O and 22 mm H₂O. The aerosol-generating article may have a resistance to draw (RTD) of between 20 mm H₂O and 55 mm H₂O. The aerosol-generating article may have a resistance to draw (RTD) of between 20 mm H₂O and 50 mm H₂O. The aerosol-generating article may have a resistance to draw (RTD) of between 25 mm H₂O and 50 mm H₂O. The aerosol-generating article may have a resistance to draw (RTD) of between 30 mm H₂O and 50 mm H₂O. The aerosol-generating article may have a resistance to draw (RTD) of between 30 mm H₂O and 45 mm H₂O. The aerosol-generating article may have a resistance to draw (RTD) of between 35 mm H₂O and 45 mm H₂O. The aerosol-generating article may have a resistance to draw (RTD) of between 35 mm H₂O and 40 mm H₂O.

The aerosol-generating article may have an external diameter of at least 5 millimetres. The aerosol-generating article may have an external diameter of at least 6 millimetres. The aerosol-generating article may have an external diameter of at least 7 millimetres. The aerosol-generating article may have an external diameter of at least 8 millimetres. The aerosol-generating article may have an external diameter of at least 9 millimetres. The aerosol-generating article may have an external diameter of at least 10 millimetres.

The aerosol-generating article may have an external diameter of less than or equal to about 12 millimetres. The aerosol-generating article may have an external diameter of less than or equal to about 11 millimetres. The aerosol-generating article may have an external diameter of less than or equal to about 10 millimetres. The aerosol-generating article may have an external diameter of less than or equal to about 9 millimetres. The aerosol-generating article may have an external diameter of less than or equal to about 8 millimetres. The aerosol-generating article may have an external diameter of less than or equal to about 7 millimetres. The aerosol-generating article may have an external diameter of less than or equal to about 6 millimetres.

The aerosol-generating article may have an external diameter of between about 5 millimetres and about 12 millimetres. The aerosol-generating article may have an external diameter of between about 6 millimetres and about 12 millimetres. The aerosol-generating article may have an external diameter of between about 6 millimetres and about 11 millimetres. The aerosol-generating article may have an external diameter of between about 7 millimetres and about 11 millimetres. The aerosol-generating article may have an external diameter of between about 7 millimetres and about 10 millimetres. The aerosol-generating article may have an external diameter of between about 6 millimetres and about 9 millimetres. The aerosol-generating article may have an external diameter of between about 7 millimetres and about 8 millimetres.

The external diameter of the aerosol-generating article may be substantially uniform along its length.

The aerosol-generating article may have a weight of at least 350 milligrams. The aerosol-generating article may have a weight of at least 400 milligrams. The aerosol-generating article may have a weight of at least 450 milligrams. The aerosol-generating article may have a weight of at least 500 milligrams.

The aerosol-generating article may have a weight of less than or equal to 700 milligrams. The aerosol-generating article may have a weight of less than or equal to 650 milligrams. The aerosol-generating article may have a weight of less than or equal to 600 milligrams. The aerosol-generating article may have a weight of less than or equal to 550 milligrams. The aerosol-generating article may have a weight of less than or equal to 500 milligrams.

The aerosol-generating article may have a weight of between 350 milligrams and 700 milligrams. The aerosol-generating article may have a weight of between 350 milligrams and 650 milligrams. The aerosol-generating article may have a weight of between 400 milligrams and 650 milligrams. The aerosol-generating article may have a weight of between 400 milligrams and 600 milligrams. The aerosol-generating article may have a weight of between 450 milligrams and 600 milligrams. The aerosol-generating article may have a weight of between 450 milligrams and 550 milligrams. The aerosol-generating article may have a weight of between 500 milligrams and 550 milligrams.

As used herein with reference to the present invention, the term “susceptor element” refers to a material that can convert electromagnetic energy into heat. When located within a fluctuating electromagnetic field, eddy currents induced in the susceptor element cause heating of the susceptor element. As the susceptor element is located in thermal contact with the aerosol-forming substrate, the aerosol-forming substrate is heated by the susceptor element.

The aerosol-generating article may comprise one or more susceptor elements. The aerosol-generating article may comprise a plurality of susceptor elements.

The aerosol-generating article may comprise a wrapper. The aerosol-generating article may comprise a wrapper circumscribing at least the aerosol-forming substrate section.

The wrapper may be a paper wrapper.

Advantageously, decreasing the density of the wrapper may decrease the weight of the wrapper, which may allow for an increased weight of aerosol-forming substrate while keeping the weight of the aerosol-generating article the same. Increasing the weight of the aerosol-forming substrate may decrease the ratio of the weight of the downstream section to the weight of the aerosol-forming substrate.

The wrapper may have a grammage of at least 15 gsm. The wrapper may have a grammage of at least 20 gsm. The wrapper may have a grammage of at least 25 gsm. The wrapper may have a grammage of at least 30 gsm.

The wrapper may have a grammage of less than or equal to 35 gsm. The wrapper may have a grammage of less than or equal to 30 gsm. The wrapper may have a grammage of less than or equal to 25 gsm. The wrapper may have a grammage of less than or equal to 20 gsm.

The wrapper may have a grammage of between 15 gsm and 35 gsm. The wrapper may have a grammage of between 15 gsm and 30 gsm. The wrapper may have a grammage of between 20 gsm and 30 gsm. The wrapper may have a grammage of between 20 gsm and 25 gsm.

Advantageously, decreasing the thickness of the wrapper may decrease the weight of the wrapper, which may allow for an increased weight of aerosol-forming substrate while keeping the weight of the aerosol-generating article the same. Increasing the weight of the aerosol-forming substrate may decrease the ratio of the weight of the downstream section to the weight of the aerosol-forming substrate.

The wrapper may have a thickness of at least 25 micrometres. The wrapper may have a thickness of at least 30 micrometres. The wrapper may have a thickness of at least 35 micrometres. The wrapper may have a thickness of at least 40 micrometres. The wrapper may have a thickness of at least 45 micrometres. The wrapper may have a thickness of at least 50 micrometres.

The wrapper may have a thickness of less than or equal to 55 micrometres. The wrapper may have a thickness of less than or equal to 50 micrometres. The wrapper may have a thickness of less than or equal to 45 micrometres. The wrapper may have a thickness of less than or equal to 40 micrometres. The wrapper may have a thickness of less than or equal to 35 micrometres. The wrapper may have a thickness of less than or equal to 30 micrometres.

The wrapper may have a thickness of between 25 micrometres and 55 micrometres. The wrapper may have a thickness of between 25 micrometres and 50 micrometres. The wrapper may have a thickness of between 30 micrometres and 50 micrometres. The wrapper may have a thickness of between 30 micrometres and 45 micrometres. The wrapper may have a thickness of between 35 micrometres and 45 micrometres. The wrapper may have a thickness of between 35 micrometres and 40 micrometres.

The aerosol-generating article may comprise a ventilation zone.

The ventilation zone may be provided at a location along the downstream section.

The ventilation zone may be provided at a location along the first hollow tubular element.

The ventilation zone may be provided at a distance of between 26 millimetres and 33 millimetres from an upstream end of the aerosol-generating article. As used herein, the term ‘distance between the ventilation zone and another element or portion of the aerosol-generating article’ refers to a distance measures in the longitudinal direction, that is, in a direction extending along, or parallel to, the cylindrical axis of the aerosol-generating article.

The ventilation level of the aerosol-generating article may be between 10 percent and 30 percent. The ventilation level of the aerosol-generating article may be between 12 percent and 25 percent.

The aerosol-generating article may comprise one or more susceptor elements provided in the aerosol-forming substrate section. The aerosol-generating article may comprise a plurality of susceptor elements provided in the aerosol-forming substrate section.

The ratio of the weight of the aerosol-forming substrate section to the weight of the aerosol-generating article may be at least 0.4. The ratio of the weight of the aerosol-forming substrate section to the weight of the aerosol-generating article may be at least 0.45. The ratio of the weight of the aerosol-forming substrate section to the weight of the aerosol-generating article may be at least 0.5. The ratio of the weight of the aerosol-forming substrate section to the weight of the aerosol-generating article may be at least 0.55. The ratio of the weight of the aerosol-forming substrate section to the weight of the aerosol-generating article may be at least 0.6. The ratio of the weight of the aerosol-forming substrate section to the weight of the aerosol-generating article may be at least 0.65. The ratio of the weight of the aerosol-forming substrate section to the weight of the aerosol-generating article may be at least 0.7. The ratio of the weight of the aerosol-forming substrate section to the weight of the aerosol-generating article may be at least 0.75. The ratio of the weight of the aerosol-forming substrate section to the weight of the aerosol-generating article may be at least 0.8. The ratio of the weight of the aerosol-forming substrate section to the weight of the aerosol-generating article may be at least 0.85.

The ratio of the weight of the aerosol-forming substrate section to the weight of the aerosol-generating article may be less than or equal to 0.9. The ratio of the weight of the aerosol-forming substrate section to the weight of the aerosol-generating article may be less than or equal to 0.85. The ratio of the weight of the aerosol-forming substrate section to the weight of the aerosol-generating article may be less than or equal to 0.8. The ratio of the weight of the aerosol-forming substrate section to the weight of the aerosol-generating article may be less than or equal to 0.75. The ratio of the weight of the aerosol-forming substrate section to the weight of the aerosol-generating article may be less than or equal to 0.7. The ratio of the weight of the aerosol-forming substrate section to the weight of the aerosol-generating article may be less than or equal to 0.65. The ratio of the weight of the aerosol-forming substrate section to the weight of the aerosol-generating article may be less than or equal to 0.6. The ratio of the weight of the aerosol-forming substrate section to the weight of the aerosol-generating article may be less than or equal to 0.55. The ratio of the weight of the aerosol-forming substrate section to the weight of the aerosol-generating article may be less than or equal to 0.5. The ratio of the weight of the aerosol-forming substrate section to the weight of the aerosol-generating article may be less than or equal to 0.45.

The ratio of the weight of the aerosol-forming substrate section to the weight of the aerosol-generating article may be between 0.4 and 0.9. The ratio of the weight of the aerosol-forming substrate section to the weight of the aerosol-generating article may be between 0.45 and 0.9. The ratio of the weight of the aerosol-forming substrate section to the weight of the aerosol-generating article may be between 0.45 and 0.85. The ratio of the weight of the aerosol-forming substrate section to the weight of the aerosol-generating article may be between 0.5 and 0.85. The ratio of the weight of the aerosol-forming substrate section to the weight of the aerosol-generating article may be between 0.5 and 0.8. The ratio of the weight of the aerosol-forming substrate section to the weight of the aerosol-generating article may be between 0.55 and 0.8. The ratio of the weight of the aerosol-forming substrate section to the weight of the aerosol-generating article may be between 0.55 and 0.75. The ratio of the weight of the aerosol-forming substrate section to the weight of the aerosol-generating article may be between 0.6 and 0.75. The ratio of the weight of the aerosol-forming substrate section to the weight of the aerosol-generating article may be between 0.6 and 0.7. The ratio of the weight of the aerosol-forming substrate section to the weight of the aerosol-generating article may be between 0.6 and 0.65.

Advantageously, increasing the length of the aerosol-forming substrate section may increase the weight of the aerosol-forming substrate. Increasing the weight of the aerosol-forming substrate may decrease the ratio of the weight of the downstream section to the weight of the aerosol-forming substrate.

The aerosol-forming substrate section may have a length of at least 8 millimetres. The aerosol-forming substrate section may have a length of at least 10 millimetres. The aerosol-forming substrate section may have a length of at least 12 millimetres. The aerosol-forming substrate section may have a length of at least 13 millimetres. The aerosol-forming substrate section may have a length of at least 14 millimetres. The aerosol-forming substrate section may have a length of at least 16 millimetres. The aerosol-forming substrate section may have a length of at least 18 millimetres. The aerosol-forming substrate section may have a length of at least 20 millimetres. The aerosol-forming substrate section may have a length of at least 22 millimetres. The aerosol-forming substrate section may have a length of at least 24 millimetres.

The aerosol-forming substrate section may have a length of less than or equal to 24 millimetres The aerosol-forming substrate section may have a length of less than or equal to 22 millimetres. The aerosol-forming substrate section may have a length of less than or equal to 20 millimetres. The aerosol-forming substrate section may have a length of less than or equal to 18 millimetres. The aerosol-forming substrate section may have a length of less than or equal to 16 millimetres. The aerosol-forming substrate section may have a length of less than or equal to 14 millimetres. The aerosol-forming substrate section may have a length of less than or equal to 12 millimetres. The aerosol-forming substrate section may have a length of less than or equal to 10 millimetres.

The aerosol-forming substrate section may have a length of between 8 millimetres and 24 millimetres. The aerosol-forming substrate section may have a length of between 8 millimetres and 22 millimetres. The aerosol-forming substrate section may have a length of between 8 millimetres and 20 millimetres. The aerosol-forming substrate section may have a length of between 10 millimetres and 20 millimetres. The aerosol-forming substrate section may have a length of between 10 millimetres and 18 millimetres. The aerosol-forming substrate section may have a length of between 12 millimetres and 18 millimetres. The aerosol-forming substrate section may have a length of between 12 millimetres and 16 millimetres. The aerosol-forming substrate section may have a length of between 14 millimetres and 16 millimetres.

The aerosol-forming substrate section may have a length of between 10 millimetres and 20 millimetres. The aerosol-forming substrate section may have a length of between 12 millimetres and 20 millimetres. The aerosol-forming substrate section may have a length of between 13 millimetres and 20 millimetres. The aerosol-forming substrate section may have a length of between 14 millimetres and 20 millimetres. The aerosol-forming substrate section may have a length of between 16 millimetres and 20 millimetres. The aerosol-forming substrate section may have a length of between 16 millimetres and 18 millimetres.

The aerosol-forming substrate section may have the same length as the aerosol-forming substrate.

The aerosol-forming substrate section may have a resistance to draw (RTD) of at least 4 mm H₂O. The aerosol-forming substrate section may have a resistance to draw (RTD) of at least 6 mm H₂O. The aerosol-forming substrate section may have a resistance to draw (RTD) of at least 8 mm H₂O. The aerosol-forming substrate section may have a resistance to draw (RTD) of at least 10 mm H₂O. The aerosol-forming substrate section may have a resistance to draw (RTD) of at least 15 mm H₂O. The aerosol-forming substrate section may have a resistance to draw (RTD) of at least 20 mm H₂O. The aerosol-forming substrate section may have a resistance to draw (RTD) of at least 25 mm H₂O. The aerosol-forming substrate section may have a resistance to draw (RTD) of at least 30 mm H₂O. The aerosol-forming substrate section may have a resistance to draw (RTD) of at least 35 mm H₂O.

The aerosol-forming substrate section may have a resistance to draw (RTD) of less than or equal to 50 mm H₂O. The aerosol-forming substrate section may have a resistance to draw (RTD) of less than or equal to 45 mm H₂O. The aerosol-forming substrate section may have a resistance to draw (RTD) of less than or equal to 40 mm H₂O. The aerosol-forming substrate section may have a resistance to draw (RTD) of less than or equal to 30 mm H₂O. The aerosol-forming substrate section may have a resistance to draw (RTD) of less than or equal to 20 mm H₂O. The aerosol-forming substrate section may have a resistance to draw (RTD) of less than or equal to 10 mm H₂O. The aerosol-forming substrate section may have a resistance to draw (RTD) of less than or equal to 8 mm H₂O. The aerosol-forming substrate section may have a resistance to draw (RTD) of less than or equal to 6 mm H₂O.

The aerosol-forming substrate section may have a resistance to draw (RTD) of between 4 mm H₂O and 50 mm H₂O. The aerosol-forming substrate section may have a resistance to draw (RTD) of between 10 mm H₂O and 40 mm H₂O. The aerosol-forming substrate section may have a resistance to draw (RTD) of between 20 mm H₂O and 40 mm H₂O. The aerosol-forming substrate section may have a resistance to draw (RTD) of between 30 mm H₂O and 40 mm H₂O.

The aerosol-forming substrate section may have the same RTD as the aerosol-forming substrate.

The aerosol-forming substrate section may have weight of at least 200 milligrams. The aerosol-forming substrate section may have weight of at least 220 milligrams. The aerosol-forming substrate section may have weight of at least 240 milligrams. The aerosol-forming substrate section may have weight of at least 260 milligrams. The aerosol-forming substrate section may have weight of at least 280 milligrams. The aerosol-forming substrate section may have weight of at least 300 milligrams. The aerosol-forming substrate section may have weight of at least 320 milligrams. The aerosol-forming substrate section may have weight of at least 340 milligrams. The aerosol-forming substrate section may have weight of at least 360 milligrams. The aerosol-forming substrate section may have weight of at least 380 milligrams. The aerosol-forming substrate section may have weight of at least 400 milligrams.

The aerosol-forming substrate section may have weight of less than or equal to 400 milligrams. The aerosol-forming substrate section may have weight of less than or equal to 380 milligrams. The aerosol-forming substrate section may have weight of less than or equal to 360 milligrams. The aerosol-forming substrate section may have weight of less than or equal to 340 milligrams. The aerosol-forming substrate section may have weight of less than or equal to 320 milligrams. The aerosol-forming substrate section may have weight of less than or equal to 300 milligrams. The aerosol-forming substrate section may have weight of less than or equal to 280 milligrams. The aerosol-forming substrate section may have weight of less than or equal to 260 milligrams. The aerosol-forming substrate section may have weight of less than or equal to 240 milligrams. The aerosol-forming substrate section may have weight of less than or equal to 220 milligrams. The aerosol-forming substrate section may have weight of less than or equal to 200 milligrams.

The aerosol-forming substrate section may have a weight of between 200 milligrams and 400 milligrams. The aerosol-forming substrate section may have a weight of between 200 milligrams and 380 milligrams. The aerosol-forming substrate section may have a weight of between 220 milligrams and 380 milligrams. The aerosol-forming substrate section may have a weight of between 220 milligrams and 360 milligrams. The aerosol-forming substrate section may have a weight of between 240 milligrams and 360 milligrams. The aerosol-forming substrate section may have a weight of between 240 milligrams and 340 milligrams. The aerosol-forming substrate section may have a weight of between 260 milligrams and 340 milligrams. The aerosol-forming substrate section may have a weight of between 260 milligrams and 320 milligrams. The aerosol-forming substrate section may have a weight of between 280 milligrams and 320 milligrams. The aerosol-forming substrate section may have a weight of between 280 milligrams and 300 milligrams.

The aerosol-forming substrate section may have the same weight as the aerosol-forming substrate.

The ratio of the length of the aerosol-forming substrate section to the length of the aerosol-generating article may be at least 0.3. The ratio of the length of the aerosol-forming substrate section to the length of the aerosol-generating article may be at least 0.31. The ratio of the length of the aerosol-forming substrate section to the length of the aerosol-generating article may be at least 0.33. The ratio of the length of the aerosol-forming substrate section to the length of the aerosol-generating article may be at least 0.35. The ratio of the length of the aerosol-forming substrate section to the length of the aerosol-generating article may be at least 0.37. The ratio of the length of the aerosol-forming substrate section to the length of the aerosol-generating article may be at least 0.39. The ratio of the length of the aerosol-forming substrate section to the length of the aerosol-generating article may be at least 0.4.

The ratio of the length of the aerosol-forming substrate section to the length of the aerosol-generating article may be less than or equal to 0.6. The ratio of the length of the aerosol-forming substrate section to the length of the aerosol-generating article may be less than or equal to 0.55. The ratio of the length of the aerosol-forming substrate section to the length of the aerosol-generating article may be less than or equal to 0.5. The ratio of the length of the aerosol-forming substrate section to the length of the aerosol-generating article may be less than or equal to 0.45. The ratio of the length of the aerosol-forming substrate section to the length of the aerosol-generating article may be less than or equal to 0.4. The ratio of the length of the aerosol-forming substrate section to the length of the aerosol-generating article may be less than or equal to 0.39. The ratio of the length of the aerosol-forming substrate section to the length of the aerosol-generating article may be less than or equal to 0.37. The ratio of the length of the aerosol-forming substrate section to the length of the aerosol-generating article may be less than or equal to 0.35. The ratio of the length of the aerosol-forming substrate section to the length of the aerosol-generating article may be less than or equal to 0.33.

The ratio of the length of the aerosol-forming substrate section to the length of the aerosol-generating article may be between 0.3 and 0.6. The ratio of the length of the aerosol-forming substrate section to the length of the aerosol-generating article may be between 0.31 and 0.6. The ratio of the length of the aerosol-forming substrate section to the length of the aerosol-generating article may be between 0.33 and 0.6. The ratio of the length of the aerosol-forming substrate section to the length of the aerosol-generating article may be between 0.35 and 0.6. The ratio of the length of the aerosol-forming substrate section to the length of the aerosol-generating article may be between 0.37 and 0.6. The ratio of the length of the aerosol-forming substrate section to the length of the aerosol-generating article may be between 0.39 and 0.6. The ratio of the length of the aerosol-forming substrate section to the length of the aerosol-generating article may be between 0.4 and 0.6. The ratio of the length of the aerosol-forming substrate section to the length of the aerosol-generating article may be between 0.45 and 0.6. The ratio of the length of the aerosol-forming substrate section to the length of the aerosol-generating article may be between 0.5 and 0.6. The ratio of the length of the aerosol-forming substrate section to the length of the aerosol-generating article may be between 0.55 and 0.6.

The aerosol-forming substrate section may have a substantially uniform cross-section along the length of the aerosol-forming substrate section. The aerosol-forming substrate section may have a substantially circular cross-section.

The aerosol-forming substrate may comprise a rod of aerosol-forming substrate.

The rod of aerosol-forming substrate may comprise a substantially solid cylinder. The rod of aerosol-forming substrate may comprise a hollow cylinder.

The aerosol-forming substrate may comprise one or more aerosol formers. The aerosol-forming substrate may comprise a plurality of aerosol formers.

The aerosol-forming substrate may have an aerosol former content of at least 10 percent by weight, on a dry weight basis. The aerosol-forming substrate may have an aerosol former content of at least 15 percent by weight, on a dry weight basis. The aerosol-forming substrate may have an aerosol former content of at least 20 percent by weight, on a dry weight basis. The aerosol-forming substrate may have an aerosol former content of at least 25 percent by weight, on a dry weight basis. The aerosol-forming substrate may have an aerosol former content of at least 30 percent by weight, on a dry weight basis. The aerosol-forming substrate may have an aerosol former content of at least 35 percent by weight, on a dry weight basis. The aerosol-forming substrate may have an aerosol former content of at least 40 percent by weight, on a dry weight basis. The aerosol-forming substrate may have an aerosol former content of at least 45 percent by weight, on a dry weight basis. The aerosol-forming substrate may have an aerosol former content of at least 50 percent by weight, on a dry weight basis. The aerosol-forming substrate may have an aerosol former content of at least 55 percent by weight, on a dry weight basis. The aerosol-forming substrate may have an aerosol former content of at least 60 percent by weight, on a dry weight basis. The aerosol-forming substrate may have an aerosol former content of at least 65 percent by weight, on a dry weight basis. The aerosol-forming substrate may have an aerosol former content of at least 70 percent by weight, on a dry weight basis. The aerosol-forming substrate may have an aerosol former content of at least 75 percent by weight, on a dry weight basis. The aerosol-forming substrate may have an aerosol former content of at least 80 percent by weight, on a dry weight basis. The aerosol-forming substrate may have an aerosol former content of at least 85 percent by weight, on a dry weight basis.

The aerosol-forming substrate may have an aerosol former content of less than or equal to 90 percent by weight, on a dry weight basis. The aerosol-forming substrate may have an aerosol former content of less than or equal to 85 percent by weight, on a dry weight basis. The aerosol-forming substrate may have an aerosol former content of less than or equal to 80 percent by weight, on a dry weight basis. The aerosol-forming substrate may have an aerosol former content of less than or equal to 75 percent by weight, on a dry weight basis. The aerosol-forming substrate may have an aerosol former content of less than or equal to 70 percent by weight, on a dry weight basis. The aerosol-forming substrate may have an aerosol former content of less than or equal to 65 percent by weight, on a dry weight basis. The aerosol-forming substrate may have an aerosol former content of less than or equal to 60 percent by weight, on a dry weight basis. The aerosol-forming substrate may have an aerosol former content of less than or equal to 55 percent by weight, on a dry weight basis. The aerosol-forming substrate may have an aerosol former content of less than or equal to 50 percent by weight, on a dry weight basis. The aerosol-forming substrate may have an aerosol former content of less than or equal to 45 percent by weight, on a dry weight basis. The aerosol-forming substrate may have an aerosol former content of less than or equal to 40 percent by weight, on a dry weight basis. The aerosol-forming substrate may have an aerosol former content of less than or equal to 35 percent by weight, on a dry weight basis. The aerosol-forming substrate may have an aerosol former content of less than or equal to 30 percent by weight, on a dry weight basis. The aerosol-forming substrate may have an aerosol former content of less than or equal to 25 percent by weight, on a dry weight basis. The aerosol-forming substrate may have an aerosol former content of less than or equal to 20 percent by weight, on a dry weight basis. The aerosol-forming substrate may have an aerosol former content of less than or equal to 15 percent by weight, on a dry weight basis.

The aerosol-forming substrate may have an aerosol former content of between 0.01 percent and 30 percent by weight, on a dry weight basis. The aerosol-forming substrate may have an aerosol former content of between 5 percent and 25 percent by weight, on a dry weight basis. The aerosol-forming substrate may have an aerosol former content of between 10 percent and 20 percent by weight, on a dry weight basis.

The aerosol-forming substrate may have an aerosol former content of between 40 percent and 90 percent by weight, on a dry weight basis. The aerosol-forming substrate may have an aerosol former content of between 45 percent and 85 percent by weight, on a dry weight basis. The aerosol-forming substrate may have an aerosol former content of between 50 percent and 80 percent by weight, on a dry weight basis.

The aerosol-forming substrate may have an aerosol former content of between 55 percent and 75 percent by weight, on a dry weight basis. The aerosol-forming substrate may have an aerosol former content of between 60 percent and 70 percent by weight, on a dry weight basis.

The one or more aerosol formers may comprise one or more of glycerine and propylene glycol. The plurality of aerosol formers may comprise glycerine and propylene glycol.

Advantageously, increasing the weight of the aerosol-forming substrate may decrease the ratio of the weight of the downstream section to the weight of the aerosol-forming substrate.

The aerosol-forming substrate may have weight of at least 200 milligrams. The aerosol-forming substrate may have weight of at least 220 milligrams. The aerosol-forming substrate may have weight of at least 240 milligrams. The aerosol-forming substrate may have weight of at least 260 milligrams. The aerosol-forming substrate may have weight of at least 280 milligrams. The aerosol-forming substrate may have weight of at least 300 milligrams. The aerosol-forming substrate may have weight of at least 320 milligrams. The aerosol-forming substrate may have weight of at least 340 milligrams. The aerosol-forming substrate may have weight of at least 360 milligrams. The aerosol-forming substrate may have weight of at least 380 milligrams. The aerosol-forming substrate may have weight of at least 400 milligrams.

The aerosol-forming substrate may have weight of less than or equal to 400 milligrams. The aerosol-forming substrate may have weight of less than or equal to 380 milligrams. The aerosol-forming substrate may have weight of less than or equal to 360 milligrams. The aerosol-forming substrate may have weight of less than or equal to 340 milligrams. The aerosol-forming substrate may have weight of less than or equal to 320 milligrams. The aerosol-forming substrate may have weight of less than or equal to 300 milligrams. The aerosol-forming substrate may have weight of less than or equal to 280 milligrams. The aerosol-forming substrate may have weight of less than or equal to 260 milligrams. The aerosol-forming substrate may have weight of less than or equal to 240 milligrams. The aerosol-forming substrate may have weight of less than or equal to 220 milligrams. The aerosol-forming substrate may have weight of less than or equal to 200 milligrams.

The aerosol-forming substrate may have a weight of between 200 milligrams and 400 milligrams. The aerosol-forming substrate may have a weight of between 200 milligrams and 380 milligrams. The aerosol-forming substrate may have a weight of between 200 milligrams and 360 milligrams. The aerosol-forming substrate may have a weight of between 200 milligrams and 340 milligrams. The aerosol-forming substrate may have a weight of between 200 milligrams and 320 milligrams. The aerosol-forming substrate may have a weight of between 220 milligrams and 320 milligrams. The aerosol-forming substrate may have a weight of between 220 milligrams and 300 milligrams. The aerosol-forming substrate may have a weight of between 240 milligrams and 300 milligrams. The aerosol-forming substrate may have a weight of between 240 milligrams and 280 milligrams.

The term “density” as used herein in relation to the aerosol-forming substrate refers to the bulk density of the aerosol-forming substrate. This can be calculated by measuring the total weight of the aerosol-forming substrate and dividing this by the volume of the rod of aerosol-forming substrate (excluding any wrapper).

Advantageously, increasing the density of the aerosol-forming substrate may increase the weight of the aerosol-forming substrate. Increasing the weight of the aerosol-forming substrate may consequently decrease the ratio of the weight of the downstream section to the weight of the aerosol-forming substrate.

The aerosol-forming substrate may have a bulk density of at least 100 milligrams per cubic centimetre. The aerosol-forming substrate may have a bulk density of at least 150 milligrams per cubic centimetre. The aerosol-forming substrate may have a bulk density of at least 200 milligrams per cubic centimetre. The aerosol-forming substrate may have a bulk density of at least 250 milligrams per cubic centimetre. The aerosol-forming substrate may have a bulk density of at least 300 milligrams per cubic centimetre. The aerosol-forming substrate may have a bulk density of at least 320 milligrams per cubic centimetre. The aerosol-forming substrate may have a bulk density of at least 340 milligrams per cubic centimetre. The aerosol-forming substrate may have a bulk density of at least 360 milligrams per cubic centimetre. The aerosol-forming substrate may have a bulk density of at least 380 milligrams per cubic centimetre. The aerosol-forming substrate may have a bulk density of at least 400 milligrams per cubic centimetre. The aerosol-forming substrate may have a bulk density of at least 500 milligrams per cubic centimetre.

The aerosol-forming substrate may have a bulk density of less than or equal to 1000 milligrams per cubic centimetre. The aerosol-forming substrate may have a bulk density of less than or equal to 800 milligrams per cubic centimetre. The aerosol-forming substrate may have a bulk density of less than or equal to 700 milligrams per cubic centimetre. The aerosol-forming substrate may have a bulk density of less than or equal to 600 milligrams per cubic centimetre. The aerosol-forming substrate may have a bulk density of less than or equal to 500 milligrams per cubic centimetre. The aerosol-forming substrate may have a bulk density of less than or equal to 400 milligrams per cubic centimetre. The aerosol-forming substrate may have a bulk density of less than or equal to 380 milligrams per cubic centimetre. The aerosol-forming substrate may have a bulk density of less than or equal to 360 milligrams per cubic centimetre. The aerosol-forming substrate may have a bulk density of less than or equal to 340 milligrams per cubic centimetre. The aerosol-forming substrate may have a bulk density of less than or equal to 320 milligrams per cubic centimetre.

The aerosol-forming substrate may have a bulk density of between 100 milligrams per cubic centimetre and 1000 milligrams per cubic centimetre. The aerosol-forming substrate may have a bulk density of between 200 milligrams per cubic centimetre and 800 milligrams per cubic centimetre. The aerosol-forming substrate may have a bulk density of between 250 milligrams per cubic centimetre and 700 milligrams per cubic centimetre. The aerosol-forming substrate may have a bulk density of between 300 milligrams per cubic centimetre and 600 milligrams per cubic centimetre. The aerosol-forming substrate may have a bulk density of between 300 milligrams per cubic centimetre and 500 milligrams per cubic centimetre. The aerosol-forming substrate may have a bulk density of between 300 milligrams per cubic centimetre and 400 milligrams per cubic centimetre. The aerosol-forming substrate may have a bulk density of between 300 milligrams per cubic centimetre and 350 milligrams per cubic centimetre.

The aerosol-forming substrate may have a resistance to draw (RTD) of at least 4 mm H₂O. The aerosol-forming substrate may have a resistance to draw (RTD) of at least 6 mm H₂O. The aerosol-forming substrate may have a resistance to draw (RTD) of at least 8 mm H₂O.

The aerosol-forming substrate may have a resistance to draw (RTD) of less than or equal to 10 mm H₂O. The aerosol-forming substrate may have a resistance to draw (RTD) of less than or equal to 8 mm H₂O. The aerosol-forming substrate may have a resistance to draw (RTD) of less than or equal to 6 mm H₂O.

The aerosol-forming substrate may have a resistance to draw (RTD) of between 4 mm H₂O and 10 mm H₂O. The aerosol-forming substrate may have a resistance to draw (RTD) of between 4 mm H₂O and 8 mm H₂O. The aerosol-forming substrate may have a resistance to draw (RTD) of between 6 mm H₂O and 8 mm H₂O.

Suitable types of materials for the aerosol-forming substrate are described below and include, for example, tobacco cut filler, homogenised tobacco material such as cast leaf, aerosol-generating films and gel compositions.

The aerosol-forming substrate may be in the form of an aerosol-generating film comprising a cellulosic based film forming agent, nicotine and the aerosol former. The aerosol-generating film may further comprise a cellulose based strengthening agent. The aerosol-generating film may further comprise water, preferably 30 percent by weight of less of water.

As used herein, the term “film” is used to describe a solid laminar element having a thickness that is less than the width or length thereof. The film may be self-supporting. In other words, a film may have cohesion and mechanical properties such that the film, even if obtained by casting a film-forming formulation on a support surface, can be separated from the support surface. Alternatively, the film may be disposed on a support or sandwiched between other materials. This may enhance the mechanical stability of the film.

The aerosol-forming substate may comprise a gel composition that includes nicotine, at least one gelling agent and the aerosol former. The gel composition is preferably substantially tobacco free.

The gel composition may include at least one gelling agent. The gel composition may include a total amount of gelling agents in a range from about 0.4 percent by weight to about 10 percent by weight, or from about 0.5 percent by weight to about 8 percent by weight, or from about 1 percent by weight to about 6 percent by weight, or from about 2 percent by weight to about 4 percent by weight, or from about 2 percent by weight to about 3 percent by weight.

The term “gelling agent” refers to a compound that homogeneously, when added to a 50 percent by weight water/50 percent by weight glycerol mixture, in an amount of about 0.3 percent by weight, forms a solid medium or support matrix leading to a gel. Gelling agents include, but are not limited to, hydrogen-bond crosslinking gelling agents, and ionic crosslinking gelling agents.

The aerosol-forming substrate may comprise a shredded tobacco material. The shredded tobacco material may be tobacco cut filler. Within the context of the present specification, the term “cut filler” is used to describe to a blend of shredded plant material, such as tobacco plant material, including, in particular, one or more of leaf lamina, processed stems and ribs, homogenised plant material. The cut filler may also comprise other after-cut, filler tobacco or casing.

Advantageously, increasing the density of the shredded tobacco material may increase the weight of the aerosol-forming substrate. Increasing the weight of the aerosol-forming substrate may consequently decrease the ratio of the weight of the downstream section to the weight of the aerosol-forming substrate.

The shredded tobacco material may have a bulk density of at least 100 milligrams per cubic centimetre. The shredded tobacco material may have a bulk density of at least 150 milligrams per cubic centimetre. The shredded tobacco material may have a bulk density of at least 200 milligrams per cubic centimetre. The shredded tobacco material may have a bulk density of at least 250 milligrams per cubic centimetre. The shredded tobacco material may have a bulk density of at least 300 milligrams per cubic centimetre. The shredded tobacco material may have a bulk density of at least 320 milligrams per cubic centimetre. The shredded tobacco material may have a bulk density of at least 340 milligrams per cubic centimetre. The shredded tobacco material may have a bulk density of at least 360 milligrams per cubic centimetre. The shredded tobacco material may have a bulk density of at least 380 milligrams per cubic centimetre. The shredded tobacco material may have a bulk density of at least 400 milligrams per cubic centimetre. The shredded tobacco material may have a bulk density of at least 500 milligrams per cubic centimetre.

The shredded tobacco material may have a bulk density of less than or equal to 1000 milligrams per cubic centimetre. The shredded tobacco material may have a bulk density of less than or equal to 800 milligrams per cubic centimetre. The shredded tobacco material may have a bulk density of less than or equal to 700 milligrams per cubic centimetre. The shredded tobacco material may have a bulk density of less than or equal to 600 milligrams per cubic centimetre. The shredded tobacco material may have a bulk density of less than or equal to 500 milligrams per cubic centimetre. The shredded tobacco material may have a bulk density of less than or equal to 400 milligrams per cubic centimetre. The shredded tobacco material may have a bulk density of less than or equal to 380 milligrams per cubic centimetre. The shredded tobacco material may have a bulk density of less than or equal to 360 milligrams per cubic centimetre. The shredded tobacco material may have a bulk density of less than or equal to 340 milligrams per cubic centimetre. The shredded tobacco material may have a bulk density of less than or equal to 320 milligrams per cubic centimetre.

The shredded tobacco material may have a bulk density of between 100 milligrams per cubic centimetre and 1000 milligrams per cubic centimetre. The shredded tobacco material may have a bulk density of between 200 milligrams per cubic centimetre and 800 milligrams per cubic centimetre. The shredded tobacco material may have a bulk density of between 250 milligrams per cubic centimetre and 700 milligrams per cubic centimetre. The shredded tobacco material may have a bulk density of between 300 milligrams per cubic centimetre and 600 milligrams per cubic centimetre. The shredded tobacco material may have a bulk density of between 300 milligrams per cubic centimetre and 500 milligrams per cubic centimetre. The shredded tobacco material may have a bulk density of between 300 milligrams per cubic centimetre and 400 milligrams per cubic centimetre. The shredded tobacco material may have a bulk density of between 300 milligrams per cubic centimetre and 350 milligrams per cubic centimetre.

Advantageously, increasing the weight of the shredded tobacco material may decrease the ratio of the weight of the downstream section to the weight of the aerosol-forming substrate.

The shredded tobacco material may have weight of at least 200 milligrams. The shredded tobacco material may have weight of at least 220 milligrams. The shredded tobacco material may have weight of at least 240 milligrams. The shredded tobacco material may have weight of at least 260 milligrams. The shredded tobacco material may have weight of at least 280 milligrams. The shredded tobacco material may have weight of at least 300 milligrams. The shredded tobacco material may have weight of at least 320 milligrams. The shredded tobacco material may have weight of at least 340 milligrams. The shredded tobacco material may have weight of at least 360 milligrams. The shredded tobacco material may have weight of at least 380 milligrams. The shredded tobacco material may have weight of at least 400 milligrams.

The shredded tobacco material may have weight of less than or equal to 400 milligrams. The shredded tobacco material may have weight of less than or equal to 380 milligrams. The shredded tobacco material may have weight of less than or equal to 360 milligrams. The shredded tobacco material may have weight of less than or equal to 340 milligrams. The shredded tobacco material may have weight of less than or equal to 320 milligrams. The shredded tobacco material may have weight of less than or equal to 300 milligrams. The shredded tobacco material may have weight of less than or equal to 280 milligrams. The shredded tobacco material may have weight of less than or equal to 260 milligrams. The shredded tobacco material may have weight of less than or equal to 240 milligrams. The shredded tobacco material may have weight of less than or equal to 220 milligrams. The shredded tobacco material may have weight of less than or equal to 200 milligrams.

The shredded tobacco material may have a weight of between 200 milligrams and 400 milligrams. The shredded tobacco material may have a weight of between 200 milligrams and 380 milligrams. The shredded tobacco material may have a weight of between 200 milligrams and 360 milligrams. The shredded tobacco material may have a weight of between 200 milligrams and 340 milligrams. The shredded tobacco material may have a weight of between 200 milligrams and 320 milligrams. The shredded tobacco material may have a weight of between 220 milligrams and 320 milligrams. The shredded tobacco material may have a weight of between 220 milligrams and 300 milligrams. The shredded tobacco material may have a weight of between 240 milligrams and 300 milligrams. The shredded tobacco material may have a weight of between 240 milligrams and 280 milligrams.

The ratio of the weight of shredded tobacco material to the weight of the aerosol-generating article may be at least 0.45. The ratio of the weight of shredded tobacco material to the weight of the aerosol-generating article may be at least 0.5. The ratio of the weight of shredded tobacco material to the weight of the aerosol-generating article may be at least 0.55. The ratio of the weight of shredded tobacco material to the weight of the aerosol-generating article may be at least 0.6. The ratio of the weight of shredded tobacco material to the weight of the aerosol-generating article may be at least 0.65. The ratio of the weight of shredded tobacco material to the weight of the aerosol-generating article may be at least 0.7. The ratio of the weight of shredded tobacco material to the weight of the aerosol-generating article may be at least 0.75. The ratio of the weight of shredded tobacco material to the weight of the aerosol-generating article may be at least 0.8. The ratio of the weight of shredded tobacco material to the weight of the aerosol-generating article may be at least 0.85.

The ratio of the weight of shredded tobacco material to the weight of the aerosol-generating article may be less than or equal to 0.9. The ratio of the weight of shredded tobacco material to the weight of the aerosol-generating article may be less than or equal to 0.85. The ratio of the weight of shredded tobacco material to the weight of the aerosol-generating article may be less than or equal to 0.8. The ratio of the weight of shredded tobacco material to the weight of the aerosol-generating article may be less than or equal to 0.75. The ratio of the weight of shredded tobacco material to the weight of the aerosol-generating article may be less than or equal to 0.7. The ratio of the weight of shredded tobacco material to the weight of the aerosol-generating article may be less than or equal to 0.65. The ratio of the weight of shredded tobacco material to the weight of the aerosol-generating article may be less than or equal to 0.6. The ratio of the weight of shredded tobacco material to the weight of the aerosol-generating article may be less than or equal to 0.55. The ratio of the weight of shredded tobacco material to the weight of the aerosol-generating article may be less than or equal to 0.5.

The ratio of the weight of shredded tobacco material to the weight of the aerosol-generating article may be between 0.45 and 0.9. The ratio of the weight of shredded tobacco material to the weight of the aerosol-generating article may be between 0.45 and 0.85. The ratio of the weight of shredded tobacco material to the weight of the aerosol-generating article may be between 0.5 and 0.85. The ratio of the weight of shredded tobacco material to the weight of the aerosol-generating article may be between 0.5 and 0.8. The ratio of the weight of shredded tobacco material to the weight of the aerosol-generating article may be between 0.55 and 0.8. The ratio of the weight of shredded tobacco material to the weight of the aerosol-generating article may be between 0.55 and 0.75. The ratio of the weight of shredded tobacco material to the weight of the aerosol-generating article may be between 0.6 and 0.75. The ratio of the weight of shredded tobacco material to the weight of the aerosol-generating article may be between 0.6 and 0.7. The ratio of the weight of shredded tobacco material to the weight of the aerosol-generating article may be between 0.65 and 0.7.

The downstream section may be provided at a downstream end of the aerosol-forming substrate section.

Advantageously, decreasing the weight of the downstream section may decrease the ratio of the weight of the downstream section to the weight of the aerosol-forming substrate.

The downstream section may have a weight of at least 100 milligrams. The downstream section may have a weight of at least 120 milligrams. The downstream section may have a weight of at least 140 milligrams. The downstream section may have a weight of at least 160 milligrams. The downstream section may have a weight of at least 180 milligrams The downstream section may have a weight of at least 200 milligrams. The downstream section may have a weight of at least 220 milligrams. The downstream section may have a weight of at least 240 milligrams. The downstream section may have a weight of at least 260 milligrams. The downstream section may have a weight of at least 280 milligrams. The downstream section may have a weight of at least 300 milligrams.

The downstream section may have a weight of less than or equal to 300 milligrams. The downstream section may have a weight of less than or equal to 280 milligrams. The downstream section may have a weight of less than or equal to 260 milligrams. The downstream section may have a weight of less than or equal to 240 milligrams. The downstream section may have a weight of less than or equal to 220 milligrams. The downstream section may have a weight of less than or equal to 200 milligrams. The downstream section may have a weight of less than or equal to 180 milligrams. The downstream section may have a weight of less than or equal to 160 milligrams. The downstream section may have a weight of less than or equal to 140 milligrams. The downstream section may have a weight of less than or equal to 120 milligrams.

The downstream section may have a weight of between 100 milligrams and 300 milligrams. The downstream section may have a weight of between 100 milligrams and 280 milligrams. The downstream section may have a weight of between 120 milligrams and 280 milligrams. The downstream section may have a weight of between 120 milligrams and 260 milligrams. The downstream section may have a weight of between 140 milligrams and 260 milligrams. The downstream section may have a weight of between 140 milligrams and 240 milligrams. The downstream section may have a weight of between 160 milligrams and 220 milligrams. The downstream section may have a weight of between 180 milligrams and 220 milligrams.

The ratio of the weight of the downstream section to the weight of the aerosol-generating article may be at least 0.25. The ratio of the weight of the downstream section to the weight of the aerosol-generating article may be at least 0.26. The ratio of the weight of the downstream section to the weight of the aerosol-generating article may be at least 0.28. The ratio of the weight of the downstream section to the weight of the aerosol-generating article may be at least 0.3. The ratio of the weight of the downstream section to the weight of the aerosol-generating article may be at least 0.32. The ratio of the weight of the downstream section to the weight of the aerosol-generating article may be at least 0.33. The ratio of the weight of the downstream section to the weight of the aerosol-generating article may be at least 0.34. The ratio of the weight of the downstream section to the weight of the aerosol-generating article may be at least 0.36. The ratio of the weight of the downstream section to the weight of the aerosol-generating article may be at least 0.38. The ratio of the weight of the downstream section to the weight of the aerosol-generating article may be at least 0.4. The ratio of the weight of the downstream section to the weight of the aerosol-generating article may be at least 0.42. The ratio of the weight of the downstream section to the weight of the aerosol-generating article may be at least 0.44. The ratio of the weight of the downstream section to the weight of the aerosol-generating article may be at least 0.45. The ratio of the weight of the downstream section to the weight of the aerosol-generating article may be at least 0.5. The ratio of the weight of the downstream section to the weight of the aerosol-generating article may be at least 0.55. The ratio of the weight of the downstream section to the weight of the aerosol-generating article may be at least 0.6.

The ratio of the weight of the downstream section to the weight of the aerosol-generating article may be less than or equal to 0.65. The ratio of the weight of the downstream section to the weight of the aerosol-generating article may be less than or equal to 0.6. The ratio of the weight of the downstream section to the weight of the aerosol-generating article may be less than or equal to 0.55. The ratio of the weight of the downstream section to the weight of the aerosol-generating article may be less than or equal to 0.5. The ratio of the weight of the downstream section to the weight of the aerosol-generating article may be less than or equal to 0.48. The ratio of the weight of the downstream section to the weight of the aerosol-generating article may be less than or equal to 0.46. The ratio of the weight of the downstream section to the weight of the aerosol-generating article may be less than or equal to 0.44. The ratio of the weight of the downstream section to the weight of the aerosol-generating article may be less than or equal to 0.42. The ratio of the weight of the downstream section to the weight of the aerosol-generating article may be less than or equal to 0.4. The ratio of the weight of the downstream section to the weight of the aerosol-generating article may be less than or equal to 0.38. The ratio of the weight of the downstream section to the weight of the aerosol-generating article may be less than or equal to 0.36. The ratio of the weight of the downstream section to the weight of the aerosol-generating article may be less than or equal to 0.34. The ratio of the weight of the downstream section to the weight of the aerosol-generating article may be less than or equal to 0.33. The ratio of the weight of the downstream section to the weight of the aerosol-generating article may be less than or equal to 0.32. The ratio of the weight of the downstream section to the weight of the aerosol-generating article may be less than or equal to 0.3. The ratio of the weight of the downstream section to the weight of the aerosol-generating article may be less than or equal to 0.28. The ratio of the weight of the downstream section to the weight of the aerosol-generating article may be less than or equal to 0.26. The ratio of the weight of the downstream section to the weight of the aerosol-generating article may be less than or equal to 0.25. The ratio of the weight of the downstream section to the weight of the aerosol-generating article may be less than or equal to 0.24. The ratio of the weight of the downstream section to the weight of the aerosol-generating article may be less than or equal to 0.22. The ratio of the weight of the downstream section to the weight of the aerosol-generating article may be less than or equal to 0.2.

The ratio of the weight of the downstream section to the weight of the aerosol-generating article may be between 0.2 and 0.6. The ratio of the weight of the downstream section to the weight of the aerosol-generating article may be between 0.2 and 0.55. The ratio of the weight of the downstream section to the weight of the aerosol-generating article may be between 0.22 and 0.55. The ratio of the weight of the downstream section to the weight of the aerosol-generating article may be between 0.22 and 0.5. The ratio of the weight of the downstream section to the weight of the aerosol-generating article may be between 0.24 and 0.5. The ratio of the weight of the downstream section to the weight of the aerosol-generating article may be between 0.24 and 0.48. The ratio of the weight of the downstream section to the weight of the aerosol-generating article may be between 0.26 and 0.48. The ratio of the weight of the downstream section to the weight of the aerosol-generating article may be between 0.26 and 0.46. The ratio of the weight of the downstream section to the weight of the aerosol-generating article may be between 0.28 and 0.46. The ratio of the weight of the downstream section to the weight of the aerosol-generating article may be between 0.28 and 0.44. The ratio of the weight of the downstream section to the weight of the aerosol-generating article may be between 0.3 and 0.44. The ratio of the weight of the downstream section to the weight of the aerosol-generating article may be between 0.3 and 0.42. The ratio of the weight of the downstream section to the weight of the aerosol-generating article may be between 0.31 and 0.42. The ratio of the weight of the downstream section to the weight of the aerosol-generating article may be between 0.31 and 0.4.

Advantageously, decreasing the length of the downstream section may decrease the weight of the downstream section. Decreasing the weight of the downstream section may decrease the ratio of the weight of the downstream section to the weight of the aerosol-forming substrate.

The downstream section may have a length of at least 16 millimetres. The downstream section may have a length of at least 18 millimetres. The downstream section may have a length of at least 20 millimetres. The downstream section may have a length of at least 22 millimetres. The downstream section may have a length of at least 24 millimetres. The downstream section may have a length of at least 26 millimetres. The downstream section may have a length of at least 28 millimetres.

The downstream section may have a length of less than or equal to 40 millimetres. The downstream section may have a length of less than or equal to 38 millimetres. The downstream section may have a length of less than or equal to 36 millimetres. The downstream section may have a length of less than or equal to 34 millimetres. The downstream section may have a length of less than or equal to 32 millimetres. The downstream section may have a length of less than or equal to 30 millimetres. The downstream section may have a length of less than or equal to 28 millimetres. The downstream section may have a length of less than or equal to 26 millimetres. The downstream section may have a length of less than or equal to 25 millimetres. The downstream section may have a length of less than or equal to 24 millimetres. The downstream section may have a length of less than or equal to 22 millimetres. The downstream section may have a length of less than or equal to 20 millimetres.

The downstream section may have a length of between 16 millimetres and 40 millimetres. The downstream section may have a length of between 16 millimetres and 38 millimetres. The downstream section may have a length of between 18 millimetres and 36 millimetres. The downstream section may have a length of between 18 millimetres and 34 millimetres. The downstream section may have a length of between 20 millimetres and 32 millimetres. The downstream section may have a length of between 20 millimetres and 30 millimetres. The downstream section may have a length of between 22 millimetres and 28 millimetres.

The downstream section may have a resistance to draw (RTD) of at least 0.01 mm H₂O. The downstream section may have a resistance to draw (RTD) of at least 1 mm H₂O. The downstream section may have a resistance to draw (RTD) of at least 3 mm H₂O. The downstream section may have a resistance to draw (RTD) of at least 5 mm H₂O.

The downstream section may have a resistance to draw (RTD) of less than or equal to 20 mm H₂O. The downstream section may have a resistance to draw (RTD) of less than or equal to 15 mm H₂O. The downstream section may have a resistance to draw (RTD) of less than or equal to 10 mm H₂O. The downstream section may have a resistance to draw (RTD) of less than or equal to 5 mm H₂O. The downstream section may have a resistance to draw (RTD) of less than or equal to 3 mm H₂O The downstream section may have a resistance to draw (RTD) of less than or equal to 1 mm H₂O. The downstream section may have a resistance to draw (RTD) of less than or equal to 0.01 mm H₂O.

The downstream section may have a resistance to draw (RTD) of between 0.01 mm H₂O and 20 mm H₂O. The downstream section may have a resistance to draw (RTD) of between 0.01 mm H₂O and 15 mm H₂O. The downstream section may have a resistance to draw (RTD) of between 1 mm H₂O and 15 mm H₂O. The downstream section may have a resistance to draw (RTD) of between 1 mm H₂O and 10 mm H₂O. The downstream section may have a resistance to draw (RTD) of between 3 mm H₂O and 10 mm H₂O.

The ratio of the weight of the aerosol-forming substrate to the weight of the aerosol-generating article may be at least 0.45. The ratio of the weight of the aerosol-forming substrate to the weight of the aerosol-generating article may be at least 0.5. The ratio of the weight of the aerosol-forming substrate to the weight of the aerosol-generating article may be at least 0.55. The ratio of the weight of the aerosol-forming substrate to the weight of the aerosol-generating article may be at least 0.6. The ratio of the weight of the aerosol-forming substrate to the weight of the aerosol-generating article may be at least 0.65. The ratio of the weight of the aerosol-forming substrate to the weight of the aerosol-generating article may be at least 0.7. The ratio of the weight of the aerosol-forming substrate to the weight of the aerosol-generating article may be at least 0.75. The ratio of the weight of the aerosol-forming substrate to the weight of the aerosol-generating article may be at least 0.8. The ratio of the weight of the aerosol-forming substrate to the weight of the aerosol-generating article may be at least 0.85. The ratio of the weight of the aerosol-forming substrate to the weight of the aerosol-generating article may be at least 0.9.

The ratio of the weight of the aerosol-forming substrate to the weight of the aerosol-generating article may be less than or equal to 0.9. The ratio of the weight of the aerosol-forming substrate to the weight of the aerosol-generating article may be less than or equal to 0.85. The ratio of the weight of the aerosol-forming substrate to the weight of the aerosol-generating article may be less than or equal to 0.8. The ratio of the weight of the aerosol-forming substrate to the weight of the aerosol-generating article may be less than or equal to 0.75. The ratio of the weight of the aerosol-forming substrate to the weight of the aerosol-generating article may be less than or equal to 0.7. The ratio of the weight of the aerosol-forming substrate to the weight of the aerosol-generating article may be less than or equal to 0.65. The ratio of the weight of the aerosol-forming substrate to the weight of the aerosol-generating article may be less than or equal to 0.6. The ratio of the weight of the aerosol-forming substrate to the weight of the aerosol-generating article may be less than or equal to 0.55. The ratio of the weight of the aerosol-forming substrate to the weight of the aerosol-generating article may be less than or equal to 0.5.

The ratio of the weight of the aerosol-forming substrate to the weight of the aerosol-generating article may be between 0.45 and 0.9. The ratio of the weight of the aerosol-forming substrate to the weight of the aerosol-generating article may be between 0.5 and 0.9. The ratio of the weight of the aerosol-forming substrate to the weight of the aerosol-generating article may be between 0.5 and 0.85. The ratio of the weight of the aerosol-forming substrate to the weight of the aerosol-generating article may be between 0.55 and 0.85. The ratio of the weight of the aerosol-forming substrate to the weight of the aerosol-generating article may be between 0.55 and 0.8. The ratio of the weight of the aerosol-forming substrate to the weight of the aerosol-generating article may be between 0.6 and 0.8. The ratio of the weight of the aerosol-forming substrate to the weight of the aerosol-generating article may be between 0.6 and 0.75. The ratio of the weight of the aerosol-forming substrate to the weight of the aerosol-generating article may be between 0.65 and 0.75. The ratio of the weight of the aerosol-forming substrate to the weight of the aerosol-generating article may be between 0.65 and 0.7.

The downstream section may comprise one or more hollow tubular elements. The downstream section may comprise a plurality of hollow tubular elements. The downstream section may comprise one or more tubular elements. The downstream section may comprise a plurality of tubular elements.

The downstream section may comprise one or more solid segments. The downstream section may comprise a plurality of solid segments.

The downstream section may comprise a combination of one or more hollow tubular elements and one or more solid segments. The downstream section may comprise a combination of a plurality of a plurality of hollow tubular elements and one or more solid segments The downstream section may comprise a combination of one or more hollow tubular elements and a plurality of solid segments.

The downstream section may comprise a high ratio of hollow tubular elements to solid segments. Advantageously, providing a high ratio of hollow tubular elements to solid segments may decrease the weight of the downstream section. Decreasing the weight of the downstream section may increase the ratio of the weight of the aerosol-forming substrate to the weight of the aerosol-generating article.

The ratio of hollow tubular elements to solid segments may be at least 1. The ratio of hollow tubular elements to solid segments may be at least 2. The ratio of hollow tubular elements to solid segments may be at least 3. The ratio of hollow tubular elements to solid segments may be less than or equal to 5. The ratio of hollow tubular elements to solid segments may be less than or equal to 4. The ratio of hollow tubular elements to solid segments may be less than or equal to 3. The ratio of hollow tubular elements to solid segments may be less than or equal to 2. The ratio of hollow tubular elements to solid segments may be less than or equal to 1.

The ratio of hollow tubular elements to solid segments may be between 1 and 5. The ratio of hollow tubular elements to solid segments may be between 1 and 4. The ratio of hollow tubular elements to solid segments may be between 1 and 3. The ratio of hollow tubular elements to solid segments may be between 1 and 2.

The downstream section may comprise a solid segment abutting a downstream end of a hollow tubular element.

The downstream section may comprise a solid segment abutting a downstream end of a first hollow tubular element, and a second hollow tubular element abutting an upstream end of the first hollow tubular element.

The downstream section may comprise a solid segment abutting a downstream end of a hollow tubular element, and a downstream tubular element abutting a downstream end of the solid segment.

The downstream section may comprise a solid segment abutting a downstream end of a first hollow tubular element, a second hollow tubular element abutting an upstream end of the first hollow tubular element, and a downstream tubular element abutting a downstream end of the solid segment.

The downstream section may comprise a hollow tubular element abutting the aerosol-forming substrate section. The hollow tubular element may abut a downstream end of the aerosol-forming substrate section.

Advantageously, decreasing the length of one or more of the hollow tubular elements may decrease the weight of the downstream section. Decreasing the weight of the downstream section may decrease the ratio of the weight of the downstream section to the weight of the aerosol-forming substrate.

One or more of the hollow tubular elements may have a length of at least 3 millimetres. One or more of the hollow tubular elements may have a length of at least 4 millimetres. One or more of the hollow tubular elements may have a length of at least 5 millimetres. One or more of the hollow tubular elements may have a length of at least 6 millimetres. One or more of the hollow tubular elements may have a length of at least 8 millimetres. One or more of the hollow tubular elements may have a length of at least 10 millimetres. One or more of the hollow tubular elements may have a length of at least 12 millimetres. One or more of the hollow tubular elements may have a length of at least 14 millimetres. One or more of the hollow tubular elements may have a length of at least 15 millimetres. One or more of the hollow tubular elements may have a length of at least 17 millimetres. One or more of the hollow tubular elements may have a length of at least 19 millimetres. One or more of the hollow tubular elements may have a length of at least 21 millimetres. One or more of the hollow tubular elements may have a length of at least 23 millimetres.

One or more of the hollow tubular elements may have a length of less than or equal to 25 millimetres. One or more of the hollow tubular elements may have a length of less than or equal to 23 millimetres. One or more of the hollow tubular elements may have a length of less than or equal to 21 millimetres. One or more of the hollow tubular elements may have a length of less than or equal to 19 millimetres. One or more of the hollow tubular elements may have a length of less than or equal to 17 millimetres. One or more of the hollow tubular elements may have a length of less than or equal to 15 millimetres. One or more of the hollow tubular elements may have a length of less than or equal to 14 millimetres. One or more of the hollow tubular elements may have a length of less than or equal to 12 millimetres. One or more of the hollow tubular elements may have a length of less than or equal to 10 millimetres. One or more of the hollow tubular elements may have a length of less than or equal to 8 millimetres. One or more of the hollow tubular elements may have a length of less than or equal to 6 millimetres. One or more of the hollow tubular elements may have a length of less than or equal to 5 millimetres. One or more of the hollow tubular elements may have a length of less than or equal to 4 millimetres.

One or more of the hollow tubular elements may have a length of between 3 millimetres and 25 millimetres. One or more of the hollow tubular elements may have a length of between 3 millimetres and 20 millimetres. One or more of the hollow tubular elements may have a length of between 3 millimetres and 15 millimetres. One or more of the hollow tubular elements may have a length of between 5 millimetres and 10 millimetres.

One or more of the hollow tubular elements may have an RTD of less than or equal to 10 millimetres H₂O. One or more of the hollow tubular elements may have an RTD of less than or equal to 5 millimetres H₂O. One or more of the hollow tubular elements may have an RTD of less than or equal to 2.5 millimetres H₂O. One or more of the hollow tubular elements may have an RTD of less than or equal to 2 millimetres H₂O. One or more of the hollow tubular elements may have an RTD of less than or equal to 1 millimetre H₂O.

One or more of the hollow tubular elements may have an RTD of at least 0 millimetres H₂O. One or more of the hollow tubular elements may have an RTD of at least 0.25 millimetres H₂O. One or more of the hollow tubular elements may have an RTD of at least 0.5 millimetres H₂O. One or more of the hollow tubular elements may have an RTD of at least 1 millimetre H₂O.

One or more of the hollow tubular elements may have an RTD of between 0 millimetre H₂O and 10 millimetres H₂O. One or more of the hollow tubular elements may have an RTD of between 0.25 millimetres H₂O and 10 millimetres H₂O. One or more of the hollow tubular elements may have an RTD of between 0.5 millimetres H₂O and 10 millimetres H₂O. One or more of the hollow tubular elements may have an RTD of between 0 millimetres H₂O and 5 millimetres H₂O. One or more of the hollow tubular elements may have an RTD of between 0.25 millimetres H₂O and 5 millimetres H₂O. One or more of the hollow tubular elements may have an RTD of between 0.5 millimetres H₂O and 5 millimetres H₂O. One or more of the hollow tubular elements may have an RTD of between 1 millimetre H₂O and 5 millimetres H₂O. One or more of the hollow tubular elements may have an RTD of between 0 millimetres H₂O and 2.5 millimetres H₂O. One or more of the hollow tubular elements may have an RTD of between 0.25 millimetres H₂O and 2.5 millimetres H₂O. One or more of the hollow tubular elements may have an RTD of between 0.5 millimetres H₂O and 2.5 millimetres H₂O. One or more of the hollow tubular elements may have an RTD of between 0.5 millimetres H₂O and 2 millimetres H₂O.

Advantageously, increasing the internal volume of one or more of the hollow tubular elements may decrease the weight of the one or more of hollow tubular elements, thereby decreasing the weight of the downstream section. Decreasing the weight of the downstream section may decrease the ratio of the weight of the downstream section to the weight of the aerosol-forming substrate.

One or more of the hollow tubular elements may have an internal volume of at least 260 cubic millimetres. One or more of the hollow tubular elements may have an internal volume of at least 300 cubic millimetres. One or more of the hollow tubular elements may have an internal volume of at least 500 cubic millimetres. One or more of the hollow tubular elements may have an internal volume of at least 700 cubic millimetres.

One or more of the hollow tubular elements may have an internal volume of less than or equal to 800 cubic millimetres. One or more of the hollow tubular elements may have an internal volume of less than or equal to 700 cubic millimetres. One or more of the hollow tubular elements may have an internal volume of less than or equal to 500 cubic millimetres. One or more of the hollow tubular elements may have an internal volume of less than or equal to 300 cubic millimetres.

One or more of the hollow tubular elements may have an internal volume of between 260 cubic millimetres and 800 cubic millimetres. One or more of the hollow tubular elements may have an internal volume of between 300 cubic millimetres and 800 cubic millimetres. One or more of the hollow tubular elements may have an internal volume of between 500 cubic millimetres and 800 cubic millimetres. One or more of the hollow tubular elements may have an internal volume of between 700 cubic millimetres and 800 cubic millimetres.

Advantageously, decreasing the weight of one or more of the hollow tubular elements may decrease the weight of the downstream section. Decreasing the weight of the downstream section may decrease the ratio of the weight of the downstream section to the weight of the aerosol-forming substrate.

One or more of the hollow tubular elements may have a weight of at least 20 milligrams. One or more of the hollow tubular elements may have a weight of at least 25 milligrams. One or more of the hollow tubular elements may have a weight of at least 30 milligrams. One or more of the hollow tubular elements may have a weight of at least 35 milligrams. One or more of the hollow tubular elements may have a weight of at least 40 milligrams. One or more of the hollow tubular elements may have a weight of at least 45 milligrams. One or more of the hollow tubular elements may have a weight of at least 50 milligrams. One or more of the hollow tubular elements may have a weight of at least 55 milligrams. One or more of the hollow tubular elements may have a weight of at least 60 milligrams. One or more of the hollow tubular elements may have a weight of at least 65 milligrams. One or more of the hollow tubular elements may have a weight of at least 70 milligrams. One or more of the hollow tubular elements may have a weight of at least 75 milligrams. One or more of the hollow tubular elements may have a weight of at least 80 milligrams. One or more of the hollow tubular elements may have a weight of at least 90 milligrams. One or more of the hollow tubular elements may have a weight of at least 100 milligrams. One or more of the hollow tubular elements may have a weight of at least 110 milligrams. One or more of the hollow tubular elements may have a weight of at least 120 milligrams. One or more of the hollow tubular elements may have a weight of at least 130 milligrams. One or more of the hollow tubular elements may have a weight of at least 140 milligrams. One or more of the hollow tubular elements may have a weight of at least 150 milligrams. One or more of the hollow tubular elements may have a weight of at least 200 milligrams.

One or more of the hollow tubular elements may have a weight of less than or equal to 150 milligrams. One or more of the hollow tubular elements may have a weight of less than or equal to 140 milligrams. One or more of the hollow tubular elements may have a weight of less than or equal to 130 milligrams. One or more of the hollow tubular elements may have a weight of less than or equal to 120 milligrams. One or more of the hollow tubular elements may have a weight of less than or equal to 110 milligrams. One or more of the hollow tubular elements may have a weight of less than or equal to 100 milligrams. One or more of the hollow tubular elements may have a weight of less than or equal to 90 milligrams. One or more of the hollow tubular elements may have a weight of less than or equal to 80 milligrams. One or more of the hollow tubular elements may have a weight of less than or equal to 75 milligrams. One or more of the hollow tubular elements may have a weight of less than or equal to 70 milligrams. One or more of the hollow tubular elements may have a weight of less than or equal to 65 milligrams. One or more of the hollow tubular elements may have a weight of less than or equal to 60 milligrams. One or more of the hollow tubular elements may have a weight of less than or equal to 55 milligrams. One or more of the hollow tubular elements may have a weight of less than or equal to 50 milligrams. One or more of the hollow tubular elements may have a weight of less than or equal to 45 milligrams. One or more of the hollow tubular elements may have a weight of less than or equal to 40 milligrams. One or more of the hollow tubular elements may have a weight of less than or equal to 35 milligrams. One or more of the hollow tubular elements may have a weight of less than or equal to 30 milligrams. One or more of the hollow tubular elements may have a weight of less than or equal to 25 milligrams. One or more of the hollow tubular elements may have a weight of less than or equal to 20 milligrams.

One or more of the hollow tubular elements may have weight of between 20 milligrams and 150 milligrams. One or more of the hollow tubular elements may have weight of between 20 milligrams and 140 milligrams. One or more of the hollow tubular elements may have weight of between 20 milligrams and 130 milligrams. One or more of the hollow tubular elements may have weight of between 20 milligrams and 120 milligrams. One or more of the hollow tubular elements may have weight of between 20 milligrams and 110 milligrams. One or more of the hollow tubular elements may have weight of between 20 milligrams and 100 milligrams. One or more of the hollow tubular elements may have weight of between 20 milligrams and 90 milligrams. One or more of the hollow tubular elements may have weight of between 20 milligrams and 80 milligrams. One or more of the hollow tubular elements may have weight of between 20 milligrams and 75 milligrams. One or more of the hollow tubular elements may have weight of between 25 milligrams and 75 milligrams. One or more of the hollow tubular elements may have weight of between 25 milligrams and 70 milligrams. One or more of the hollow tubular elements may have weight of between 30 milligrams and 70 milligrams. One or more of the hollow tubular elements may have weight of between 30 milligrams and 65 milligrams. One or more of the hollow tubular elements may have weight of between 35 milligrams and 65 milligrams. One or more of the hollow tubular elements may have weight of between 35 milligrams and 60 milligrams. One or more of the hollow tubular elements may have weight of between 40 milligrams and 60 milligrams.

Advantageously, decreasing the wall thickness of one or more of the hollow tubular elements may decrease the weight of the one or more hollow tubular elements. Decreasing the weight of one or more of the hollow tubular elements may decrease the weight of the downstream section. Decreasing the weight of the downstream section may decrease the ratio of the weight of the downstream section to the weight of the aerosol-forming substrate.

One or more of the hollow tubular elements may have a wall thickness of at least 100 micrometres. One or more of the hollow tubular elements may have a wall thickness of at least 150 micrometres. One or more of the hollow tubular elements may have a wall thickness of at least 200 micrometres. One or more of the hollow tubular elements may have a wall thickness of at least 220 micrometres. One or more of the hollow tubular elements may have a wall thickness of at least 240 micrometres. One or more of the hollow tubular elements may have a wall thickness of at least 250 micrometres. One or more of the hollow tubular elements may have a wall thickness of at least 260 micrometres. One or more of the hollow tubular elements may have a wall thickness of at least 280 micrometres. One or more of the hollow tubular elements may have a wall thickness of at least 300 micrometres. One or more of the hollow tubular elements may have a wall thickness of at least 400 micrometres. One or more of the hollow tubular elements may have a wall thickness of at least 500 micrometres. One or more of the hollow tubular elements may have a wall thickness of at least 600 micrometres. One or more of the hollow tubular elements may have a wall thickness of at least 700 micrometres. One or more of the hollow tubular elements may have a wall thickness of at least 800 micrometres. One or more of the hollow tubular elements may have a wall thickness of at least 900 micrometres. One or more of the hollow tubular elements may have a wall thickness of at least 1000 micrometres. One or more of the hollow tubular elements may have a wall thickness of at least 1100 micrometres. One or more of the hollow tubular elements may have a wall thickness of at least 1200 micrometres. One or more of the hollow tubular elements may have a wall thickness of at least 1300 micrometres. One or more of the hollow tubular elements may have a wall thickness of at least 1400 micrometres. One or more of the hollow tubular elements may have a wall thickness of at least 1500 micrometres. One or more of the hollow tubular elements may have a wall thickness of at least 1600 micrometres. One or more of the hollow tubular elements may have a wall thickness of at least 1700 micrometres. One or more of the hollow tubular elements may have a wall thickness of at least 1800 micrometres. One or more of the hollow tubular elements may have a wall thickness of at least 1900 micrometres. One or more of the hollow tubular elements may have a wall thickness of at least 2000 micrometres.

One or more of the hollow tubular elements may have a wall thickness of less than or equal to 2000 micrometres. One or more of the hollow tubular elements may have a wall thickness of less than or equal to 1900 micrometres. One or more of the hollow tubular elements may have a wall thickness of less than or equal to 1800 micrometres. One or more of the hollow tubular elements may have a wall thickness of less than or equal to 1700 micrometres. One or more of the hollow tubular elements may have a wall thickness of less than or equal to 1600 micrometres. One or more of the hollow tubular elements may have a wall thickness of less than or equal to 1500 micrometres. One or more of the hollow tubular elements may have a wall thickness of less than or equal to 1400 micrometres. One or more of the hollow tubular elements may have a wall thickness of less than or equal to 1300 micrometres. One or more of the hollow tubular elements may have a wall thickness of less than or equal to 1200 micrometres. One or more of the hollow tubular elements may have a wall thickness of less than or equal to 1100 micrometres. One or more of the hollow tubular elements may have a wall thickness of less than or equal to 1000 micrometres. One or more of the hollow tubular elements may have a wall thickness of less than or equal to 900 micrometres. One or more of the hollow tubular elements may have a wall thickness of less than or equal to 800 micrometres. One or more of the hollow tubular elements may have a wall thickness of less than or equal to 700 micrometres. One or more of the hollow tubular elements may have a wall thickness of less than or equal to 600 micrometres. One or more of the hollow tubular elements may have a wall thickness of less than or equal to 500 micrometres. One or more of the hollow tubular elements may have a wall thickness of less than or equal to 400 micrometres. One or more of the hollow tubular elements may have a wall thickness of less than or equal to 380 micrometres. One or more of the hollow tubular elements may have a wall thickness of less than or equal to 360 micrometres. One or more of the hollow tubular elements may have a wall thickness of less than or equal to 340 micrometres. One or more of the hollow tubular elements may have a wall thickness of less than or equal to 320 micrometres. One or more of the hollow tubular elements may have a wall thickness of less than or equal to 300 micrometres. One or more of the hollow tubular elements may have a wall thickness of less than or equal to 280 micrometres. One or more of the hollow tubular elements may have a wall thickness of less than or equal to 260 micrometres. One or more of the hollow tubular elements may have a wall thickness of less than or equal to 240 micrometres. One or more of the hollow tubular elements may have a wall thickness of less than or equal to 220 micrometres. One or more of the hollow tubular elements may have a wall thickness of less than or equal to 200 micrometres.

One or more of the hollow tubular elements may have a wall thickness of between 100 micrometres and 2000 micrometres. One or more of the hollow tubular elements may have a wall thickness of between 200 micrometres and 1900 micrometres. One or more of the hollow tubular elements may have a wall thickness of between 300 micrometres and 1800 micrometres. One or more of the hollow tubular elements may have a wall thickness of between 400 micrometres and 1700 micrometres. One or more of the hollow tubular elements may have a wall thickness of between 500 micrometres and 1600 micrometres. One or more of the hollow tubular elements may have a wall thickness of between 600 micrometres and 1500 micrometres. One or more of the hollow tubular elements may have a wall thickness of between 700 micrometres and 1400 micrometres. One or more of the hollow tubular elements may have a wall thickness of between 800 micrometres and 1300 micrometres. One or more of the hollow tubular elements may have a wall thickness of between 900 micrometres and 1200 micrometres. One or more of the hollow tubular elements may have a wall thickness of between 1000 micrometres and 1100 micrometres.

Advantageously, forming one or more of the hollow tubular elements from a material having a low grammage may decrease the weight of one or more of the hollow tubular elements. Decreasing the weight of one or more of the hollow tubular elements may decrease the weight of the downstream section. Decreasing the weight of the downstream section may decrease the ratio of the weight of the downstream section to the weight of the aerosol-forming substrate.

One or more of the hollow tubular elements may be formed from a material having a grammage of at least 68 gsm. One or more of the hollow tubular elements may be formed from a material having a grammage of at least 70 gsm. One or more of the hollow tubular elements may be formed from a material having a grammage of at least 72 gsm. One or more of the hollow tubular elements may be formed from a material having a grammage of at least 74 gsm. One or more of the hollow tubular elements may be formed from a material having a grammage of at least 76 gsm. One or more of the hollow tubular elements may be formed from a material having a grammage of at least 78 gsm.

One or more of the hollow tubular elements may be formed from a material having a grammage of less than or equal to 90 gsm. One or more of the hollow tubular elements may be formed from a material having a grammage of less than or equal to 88 gsm. One or more of the hollow tubular elements may be formed from a material having a grammage of less than or equal to 86 gsm. One or more of the hollow tubular elements may be formed from a material having a grammage of less than or equal to 84 gsm. One or more of the hollow tubular elements may be formed from a material having a grammage of less than or equal to 82 gsm. One or more of the hollow tubular elements may be formed from a material having a grammage of less than or equal to 80 gsm. One or more of the hollow tubular elements may be formed from a material having a grammage of less than or equal to 78 gsm. One or more of the hollow tubular elements may be formed from a material having a grammage of less than or equal to 76 gsm. One or more of the hollow tubular elements may be formed from a material having a grammage of less than or equal to 74 gsm. T One or more of the hollow tubular elements may be formed from a material having a grammage of less than or equal to 72 gsm. One or more of the hollow tubular elements may be formed from a material having a grammage of less than or equal to 70 gsm. One or more of the hollow tubular elements may be formed from a material having a grammage of less than or equal to 68 gsm.

One or more of the hollow tubular elements may be formed from a material having a grammage of between 60 gsm and 90 gsm. One or more of the hollow tubular elements may be formed from a material having a grammage of between 60 gsm and 88 gsm. One or more of the hollow tubular elements may be formed from a material having a grammage of between 62 gsm and 88 gsm. One or more of the hollow tubular elements may be formed from a material having a grammage of between 62 gsm and 86 gsm. One or more of the hollow tubular elements may be formed from a material having a grammage of between 64 gsm and 86 gsm. One or more of the hollow tubular elements may be formed from a material having a grammage of between 64 gsm and 84 gsm. One or more of the hollow tubular elements may be formed from a material having a grammage of between 66 gsm and 84 gsm. One or more of the hollow tubular elements may be formed from a material having a grammage of between 66 gsm and 82 gsm. One or more of the hollow tubular elements may be formed from a material having a grammage of between 68 gsm and 82 gsm. One or more of the hollow tubular elements may be formed from a material having a grammage of between 68 gsm and 80 gsm. One or more of the hollow tubular elements may be formed from a material having a grammage of between 70 gsm and 80 gsm. One or more of the hollow tubular elements may be formed from a material having a grammage of between 70 gsm and 78 gsm.

One or more of the hollow tubular elements may be formed from cellulose acetate. One or more of the hollow tubular elements may be formed from a paper-based material. One or more of the hollow tubular elements may be formed from paper. The paper may be very rigid paper. The paper may be crimped paper, such as crimped heat resistant paper or crimped parchment paper. One or more of the hollow tubular elements may be a paper tube. One or more of the hollow tubular elements may be a tube formed from spirally wound paper. One or more of the hollow tubular elements may be formed from a plurality of layers of the paper. The paper may have a basis weight of at least 50 grams per square meter, at least 60 grams per square meter, at least 70 grams per square meter, or at least 90 grams per square meter.

One or more of the hollow tubular elements may be formed from cardboard. One or more of the hollow tubular elements may be a cardboard tube.

One or more of the hollow tubular elements may be formed from any suitable material or combination of materials. For example, one or more of the hollow tubular elements may be formed from one or more materials selected from the group consisting of: cellulose acetate; cardboard; crimped paper, such as crimped heat resistant paper or crimped parchment paper; and polymeric materials, such as low density polyethylene (LDPE). In a preferred embodiment, one or more of the hollow tubular elements is formed from cellulose acetate. Other suitable materials include polyhydroxyalkanoate (PHA) fibres. In a preferred embodiment, one or more of the hollow tubular elements may be a hollow acetate tube.

Advantageously, forming one or more of the hollow tubular elements from a material having a low density may decrease the weight of the one or more hollow tubular elements. Decreasing the weight of the one or more hollow tubular elements may decrease the weight of the downstream section. Decreasing the weight of the downstream section may decrease the ratio of the weight of the downstream section to the weight of the aerosol-forming substrate.

One or more of the hollow tubular elements may be formed from a material having a density of at least 150 milligrams per cubic centimetre. One or more of the hollow tubular elements may be formed from a material having a density of at least 200 milligrams per cubic centimetre. One or more of the hollow tubular elements may be formed from a material having a density of at least 250 milligrams per cubic centimetre. One or more of the hollow tubular elements may be formed from a material having a density of at least 300 milligrams per cubic centimetre.

One or more of the hollow tubular elements may be formed from a material having a density of less than or equal to 400 milligrams per cubic centimetre. One or more of the hollow tubular elements may be formed from a material having a density of less than or equal to 350 milligrams per cubic centimetre. One or more of the hollow tubular elements may be formed from a material having a density of less than or equal to 300 milligrams per cubic centimetre. One or more of the hollow tubular elements may be formed from a material having a density of less than or equal to 250 milligrams per cubic centimetre. One or more of the hollow tubular elements may be formed from a material having a density of less than or equal to 200 milligrams per cubic centimetre. One or more of the hollow tubular elements may be formed from a material having a density of less than or equal to 150 milligrams per cubic centimetre.

One or more of the hollow tubular elements may be formed from a material having a density of between 150 milligrams per cubic centimetre and 400 milligrams per cubic centimetre. One or more of the hollow tubular elements may be formed from a material having a density of between 150 milligrams per cubic centimetre and 350 milligrams per cubic centimetre. One or more of the hollow tubular elements may be formed from a material having a density of between 150 milligrams per cubic centimetre and 300 milligrams per cubic centimetre. One or more of the hollow tubular elements may be formed from a material having a density of between 200 milligrams per cubic centimetre and 300 milligrams per cubic centimetre. One or more of the hollow tubular elements may be formed from a material having a density of between 200 milligrams per cubic centimetre and 250 milligrams per cubic centimetre.

One or more of the hollow tubular elements may comprise a tubular element comprising a tubular body defining a cavity. The cavity may extend from a first end of the tubular body to a second end of the tubular body. The tubular element may further comprise a folded end portion forming a first end wall at the first end of the tubular body. The first end wall may delimit an opening for airflow between the cavity and the exterior of the tubular element. The opening may have an area, as measured perpendicular to the longitudinal direction of the tubular element, of from about 0.6 percent to about 60 percent of the area of the cavity.

One or more of the hollow tubular elements may comprise a second folded end portion forming a second end wall at the second end of the tubular body, the second end wall delimiting a second opening for airflow between the empty cavity and the exterior of the tubular element.

One or more of the hollow tubular elements may have a weight of less than or equal to 10 milligrams per millimetre length of the hollow tubular element. One or more of the hollow tubular elements may have a weight of less than or equal to 6 milligrams per millimetre length of the hollow tubular element. Providing a hollow tubular element with such average weight may advantageously enable the hollow tubular element to be assembled into an aerosol-generating article using existing high speed aerosol-generating article assembly machines.

One or more of the hollow tubular elements may have a weight of between 1 and 10 milligrams per millimetre length of the hollow tubular element. One or more of the hollow tubular elements may have a weight of between 1.5 and 8 milligrams per millimetre length of the hollow tubular element. One or more of the hollow tubular elements may have a weight of between 2 and 6 milligrams per millimetre length of the hollow tubular element.

One or more of the hollow tubular elements may have a weight of 4.25 milligrams per millimetre length of the hollow tubular element.

Advantageously, increasing the combined internal volume of the one or more hollow tubular elements may decrease the combined weight of the one or more hollow tubular elements, thereby decreasing the weight of the downstream section. Decreasing the weight of the downstream section may decrease the ratio of the weight of the downstream section to the weight of the aerosol-forming substrate.

The one or more hollow tubular elements may have a combined internal volume of at least 260 cubic millimetres. The one or more hollow tubular elements may have a combined internal volume of at least 300 cubic millimetres. The one or more hollow tubular elements may have a combined internal volume of at least 500 cubic millimetres. The one or more hollow tubular elements may have a combined internal volume of at least 700 cubic millimetres.

The one or more hollow tubular elements may have a combined internal volume of less than or equal to 800 cubic millimetres. The one or more hollow tubular elements may have a combined internal volume of less than or equal to 700 cubic millimetres. The one or more hollow tubular elements may have a combined internal volume of less than or equal to 500 cubic millimetres. The one or more hollow tubular elements may have a combined internal volume of less than or equal to 300 cubic millimetres.

The one or more hollow tubular elements may have a combined internal volume of between 260 cubic millimetres and 800 cubic millimetres. The one or more hollow tubular elements may have a combined internal volume of between 300 cubic millimetres and 800 cubic millimetres. The one or more hollow tubular elements may have a combined internal volume of between 500 cubic millimetres and 800 cubic millimetres. The one or more hollow tubular elements may have a combined internal volume of between 700 cubic millimetres and 800 cubic millimetres.

The one or more solid segments may comprise a downstream filter segment. The one or more solid segments may comprise a plurality of downstream filter segments.

The downstream section may comprise a downstream filter segment. The downstream filter segment may comprise at least one filter segment formed of a fibrous filtration material. The downstream filter segment may comprise at least one filter segment formed of cardboard.

Advantageously, decreasing the length of the downstream filter segment may decrease the weight of the downstream filter segment. Decreasing the weight of the downstream filter segment may decrease the weight of the downstream section. Decreasing the weight of the downstream section may decrease the ratio of the weight of the downstream section to the weight of the aerosol-forming substrate.

The downstream filter segment may have a length of at least 3 millimetres. The downstream filter segment may have a length of at least 5 millimetres. The downstream filter segment may have a length of at least 7 millimetres. The downstream filter segment may have a length of at least 9 millimetres.

The downstream filter segment may have a length of less than or equal to 11 millimetres. The downstream filter segment may have a length of less than or equal to 9 millimetres. The downstream filter segment may have a length of less than or equal to 7 millimetres. The downstream filter segment may have a length of less than or equal to 5 millimetres.

The downstream filter segment may have a length of between 3 millimetres and 11 millimetres. The downstream filter segment may have a length of between 3 millimetres and 9 millimetres. The downstream filter segment may have a length of between 5 millimetres and 9 millimetres. The downstream filter segment may have a length of between 5 millimetres and 7 millimetres.

The downstream filter segment may have a resistance to draw (RTD) of at least 4 mmH₂O. The downstream filter segment may have a resistance to draw (RTD) of at least 5 mmH₂O. The downstream filter segment may have a resistance to draw (RTD) of at least 7 mmH₂O. The downstream filter segment may have a resistance to draw (RTD) of at least 9 mmH₂O.

The downstream filter segment may have a resistance to draw (RTD) of less than or equal to 11 mm H₂O. The downstream filter segment may have a resistance to draw (RTD) of less than or equal to 9 mm H₂O. The downstream filter segment may have a resistance to draw (RTD) of less than or equal to 7 mm H₂O. The downstream filter segment may have a resistance to draw (RTD) of less than or equal to 5 mm H₂O.

The downstream filter segment may have a resistance to draw (RTD) of between 4 mmH₂O and 11 mm H₂O. The downstream filter segment may have a resistance to draw (RTD) of between 5 mmH₂O and 11 mm H₂O. The downstream filter segment may have a resistance to draw (RTD) of between 5 mmH₂O and 9 mm H₂O. The downstream filter segment may have a resistance to draw (RTD) of between 7 mmH₂O and 9 mm H₂O.

Advantageously, decreasing the weight of the downstream filter segment may decrease the weight of the downstream section. Decreasing the weight of the downstream section may decrease the ratio of the weight of the downstream section to the weight of the aerosol-forming substrate.

The downstream filter segment may have a weight of at least 50 milligrams. The downstream filter segment may have a weight of at least 52 milligrams. The downstream filter segment may have a weight of at least 54 milligrams. The downstream filter segment may have a weight of at least 56 milligrams. The downstream filter segment may have a weight of at least 58 milligrams. The downstream filter segment may have a weight of at least 60 milligrams.

The downstream filter segment may have a weight of less than or equal to 70 milligrams. The downstream filter segment may have a weight of less than or equal to 68 milligrams. The downstream filter segment may have a weight of less than or equal to 66 milligrams. The downstream filter segment may have a weight of less than or equal to 64 milligrams. The downstream filter segment may have a weight of less than or equal to 62 milligrams. The downstream filter segment may have a weight of less than or equal to 60 milligrams. The downstream filter segment may have a weight of less than or equal to 58 milligrams. The downstream filter segment may have a weight of less than or equal to 56 milligrams. The downstream filter segment may have a weight of less than or equal to 54 milligrams. The downstream filter segment may have a weight of less than or equal to 52 milligrams. The downstream filter segment may have a weight of less than or equal to 50 milligrams.

The downstream filter segment may have a weight of between 50 milligrams and 70 milligrams. The downstream filter segment may have a weight of between 50 milligrams and 68 milligrams. The downstream filter segment may have a weight of between 52 milligrams and 68 milligrams. The downstream filter segment may have a weight of between 52 milligrams and 66 milligrams. The downstream filter segment may have a weight of between 54 milligrams and 66 milligrams. The downstream filter segment may have a weight of between 54 milligrams and 64 milligrams. The downstream filter segment may have a weight of between 56 milligrams and 64 milligrams. The downstream filter segment may have a weight of between 56 milligrams and 62 milligrams. The downstream filter segment may have a weight of between 58 milligrams and 62 milligrams.

Advantageously, forming the downstream filter segment from a material having a low density may decrease the weight of the downstream filter segment. Decreasing the weight of the downstream filter segment may decrease the weight of the downstream section. Decreasing the weight of the downstream section may decrease the ratio of the weight of the downstream section to the weight of the aerosol-forming substrate.

The downstream filter segment may be formed from a material having a density of at least 100 milligrams per cubic centimetre. The downstream filter segment may be formed from a material having a density of at least 120 milligrams per cubic centimetre. The downstream filter segment may be formed from a material having a density of at least 140 milligrams per cubic centimetre. The downstream filter segment may be formed from a material having a density of at least 160 milligrams per cubic centimetre. The downstream filter segment may be formed from a material having a density of at least 180 milligrams per cubic centimetre. The downstream filter segment may be formed from a material having a density of at least 200 milligrams per cubic centimetre. The downstream filter segment may be formed from a material having a density of at least 220 milligrams per cubic centimetre.

The downstream filter segment may be formed from a material having a density of less than or equal to 240 milligrams per cubic centimetre. The downstream filter segment may be formed from a material having a density of less than or equal to 220 milligrams per cubic centimetre. The downstream filter segment may be formed from a material having a density of less than or equal to 200 milligrams per cubic centimetre. The downstream filter segment may be formed from a material having a density of less than or equal to 180 milligrams per cubic centimetre. The downstream filter segment may be formed from a material having a density of less than or equal to 160 milligrams per cubic centimetre. The downstream filter segment may be formed from a material having a density of less than or equal to 140 milligrams per cubic centimetre. The downstream filter segment may be formed from a material having a density of less than or equal to 120 milligrams per cubic centimetre. The downstream filter segment may be formed from a material having a density of less than or equal to 100 milligrams per cubic centimetre.

The downstream filter segment may be formed from a material having a density of between 100 milligrams per cubic centimetre and 240 milligrams per cubic centimetre. The downstream filter segment may be formed from a material having a density of between 120 milligrams per cubic centimetre and 240 milligrams per cubic centimetre. The downstream filter segment may be formed from a material having a density of between 120 milligrams per cubic centimetre and 220 milligrams per cubic centimetre. The downstream filter segment may be formed from a material having a density of between 140 milligrams per cubic centimetre and 220 milligrams per cubic centimetre. The downstream filter segment may be formed from a material having a density of between 140 milligrams per cubic centimetre and 200 milligrams per cubic centimetre. The downstream filter segment may be formed from a material having a density of between 160 milligrams per cubic centimetre and 200 milligrams per cubic centimetre. The downstream filter segment may be formed from a material having a density of between 160 milligrams per cubic centimetre and 180 milligrams per cubic centimetre.

Advantageously, decreasing the combined length of one or more of the hollow tubular elements and the downstream filter segment may decrease the combined weight of the one or more hollow tubular elements and the downstream filter segment. Decreasing the combined weight of the one or more hollow tubular elements and the downstream filter segment may decrease the weight of the downstream section. Decreasing the weight of the downstream section may decrease the ratio of the weight of the downstream section to the weight of the aerosol-forming substrate.

One or more of the hollow tubular elements and the downstream filter segment may have a combined length of at least 24 millimetres. One or more of the hollow tubular elements and the downstream filter segment may have a combined length of at least 26 millimetres. One or more of the hollow tubular elements and the downstream filter segment may have a combined length of at least 28 millimetres. One or more of the hollow tubular elements and the downstream filter segment may have a combined length of at least 30 millimetres.

One or more of the hollow tubular elements and the downstream filter segment may have a combined length of less than or equal to 32 millimetres. One or more of the hollow tubular elements and the downstream filter segment may have a combined length of less than or equal to 30 millimetres. One or more of the hollow tubular elements and the downstream filter segment may have a combined length of less than or equal to 28 millimetres. One or more of the hollow tubular elements and the downstream filter segment may have a combined length of less than or equal to 26 millimetres.

One or more of the hollow tubular elements and the downstream filter segment may have a combined length of between 24 millimetres and 32 millimetres. One or more of the hollow tubular elements and the downstream filter segment may have a combined length of between 26 millimetres and 32 millimetres. One or more of the hollow tubular elements and the downstream filter segment may have a combined length of between 26 millimetres and 30 millimetres. One or more of the hollow tubular elements and the downstream filter segment may have a combined length of between 28 millimetres and 30 millimetres.

The aerosol-generating article may comprise upstream section provided at an upstream end of the aerosol-forming substrate section. The upstream section may comprise an upstream element.

Advantageously, decreasing the length of the upstream element may decrease the weight of the upstream element. Decreasing the weight of the upstream element may allow for an increased weight of aerosol-forming substrate while keeping the weight of the aerosol-generating article the same. Increasing the weight of the aerosol-forming substrate may decrease the ratio of the weight of the downstream section to the weight of the aerosol-forming substrate.

The upstream element may have a length of at least 2 millimetres. The upstream element may have a length of at least 4 millimetres. The upstream element may have a length of at least 6 millimetres.

The upstream element may have a length of less than or equal to 8 millimetres. The upstream element may have a length of less than or equal to 6 millimetres. The upstream element may have a length of less than or equal to 4 millimetres.

The upstream element may have a length of between 2 millimetres and 8 millimetres. The upstream element may have a length of between 2 millimetres and 6 millimetres. The upstream element may have a length of between 4 millimetres and 6 millimetres

The upstream element may be formed of a hollow tubular segment defining a longitudinal cavity providing an unrestricted flow channel.

The longitudinal cavity of the hollow tubular segment may have a diameter of at least 5 millimetres.

Advantageously, decreasing the wall thickness of the upstream element may decrease the weight of the upstream element. Decreasing the weight of the upstream element may allow for an increased weight of aerosol-forming substrate while keeping the weight of the aerosol-generating article the same. Increasing the weight of the aerosol-forming substrate may decrease the ratio of the weight of the downstream section to the weight of the aerosol-forming substrate.

The hollow tubular segment forming the upstream element may have a wall thickness of less than 1 millimetre. The hollow tubular segment may have a wall thickness of less than 0.8 millimetres. The hollow tubular segment may have a wall thickness of less than 0.6 millimetres.

The upstream element may have a resistance to draw (RTD) of less than 2 mm H₂O. The upstream element may have a resistance to draw (RTD) of less than 1 mm H₂O. The upstream element may have a resistance to draw (RTD) of less than 0.01 mm H₂O.

An upstream end of the upstream element may define an upstream end of the aerosol-generating article.

Advantageously, decreasing the weight of the upstream element may allow for an increased weight of aerosol-forming substrate while keeping the weight of the aerosol-generating article the same. Increasing the weight of the aerosol-forming substrate may decrease the ratio of the weight of the downstream section to the weight of the aerosol-forming substrate.

The upstream element may have a weight of at least 15 milligrams. The upstream element may have a weight of at least 20 milligrams. The upstream element may have a weight of at least 25 milligrams. The upstream element may have a weight of at least 30 milligrams. The upstream element may have a weight of at least 35 milligrams. The upstream element may have a weight of at least 40 milligrams. The upstream element may have a weight of at least 45 milligrams. The upstream element may have a weight of at least 50 milligrams.

The upstream element may have a weight of less than or equal to 70 milligrams. The upstream element may have a weight of less than or equal to 60 milligrams. The upstream element may have a weight of less than or equal to 55 milligrams. The upstream element may have a weight of less than or equal to 50 milligrams. The upstream element may have a weight of less than or equal to 45 milligrams. The upstream element may have a weight of less than or equal to 40 milligrams. The upstream element may have a weight of less than or equal to 35 milligrams. The upstream element may have a weight of less than or equal to 30 milligrams. The upstream element may have a weight of less than or equal to 25 milligrams. The upstream element may have a weight of less than or equal to 20 milligrams. The upstream element may have a weight of less than or equal to 15 milligrams.

The upstream element may have a weight of between 15 milligrams and 70 milligrams. The upstream element may have a weight of between 15 milligrams and 60 milligrams. The upstream element may have a weight of between 15 milligrams and 55 milligrams. The upstream element may have a weight of between 20 milligrams and 55 milligrams. The upstream element may have a weight of between 20 milligrams and 50 milligrams. The upstream element may have a weight of between 20 milligrams and 45 milligrams. The upstream element may have a weight of between 25 milligrams and 45 milligrams. The upstream element may have a weight of between 25 milligrams and 40 milligrams. The upstream element may have a weight of between 25 milligrams and 35 milligrams.

The ratio of the combined weight of the aerosol-forming substrate section and the upstream section to the weight of the aerosol-generating article may be at least 0.4. The ratio of the combined weight of the aerosol-forming substrate section and the upstream section to the weight of the aerosol-generating article may be at least 0.45. The ratio of the combined weight of the aerosol-forming substrate section and the upstream section to the weight of the aerosol-generating article may be at least 0.5. The ratio of the combined weight of the aerosol-forming substrate section and the upstream section to the weight of the aerosol-generating article may be at least 0.55. The ratio of the combined weight of the aerosol-forming substrate section and the upstream section to the weight of the aerosol-generating article may be at least 0.6. The ratio of the combined weight of the aerosol-forming substrate section and the upstream section to the weight of the aerosol-generating article may be at least 0.65. The ratio of the combined weight of the aerosol-forming substrate section and the upstream section to the weight of the aerosol-generating article may be at least 0.7. The ratio of the combined weight of the aerosol-forming substrate section and the upstream section to the weight of the aerosol-generating article may be at least 0.75. The ratio of the combined weight of the aerosol-forming substrate section and the upstream section to the weight of the aerosol-generating article may be at least 0.8. The ratio of the combined weight of the aerosol-forming substrate section and the upstream section to the weight of the aerosol-generating article may be at least 0.85. The ratio of the combined weight of the aerosol-forming substrate section and the upstream section to the weight of the aerosol-generating article may be at least 0.9.

The ratio of the combined weight of the aerosol-forming substrate section and the upstream section to the weight of the aerosol-generating article may less than or equal to 0.9. The ratio of the combined weight of the aerosol-forming substrate section and the upstream section to the weight of the aerosol-generating article may less than or equal to 0.85. The ratio of the combined weight of the aerosol-forming substrate section and the upstream section to the weight of the aerosol-generating article may less than or equal to 0.8. The ratio of the combined weight of the aerosol-forming substrate section and the upstream section to the weight of the aerosol-generating article may less than or equal to 0.75. The ratio of the combined weight of the aerosol-forming substrate section and the upstream section to the weight of the aerosol-generating article may less than or equal to 0.7. The ratio of the combined weight of the aerosol-forming substrate section and the upstream section to the weight of the aerosol-generating article may less than or equal to 0.65. The ratio of the combined weight of the aerosol-forming substrate section and the upstream section to the weight of the aerosol-generating article may less than or equal to 0.6. The ratio of the combined weight of the aerosol-forming substrate section and the upstream section to the weight of the aerosol-generating article may less than or equal to 0.55. The ratio of the combined weight of the aerosol-forming substrate section and the upstream section to the weight of the aerosol-generating article may less than or equal to 0.5. The ratio of the combined weight of the aerosol-forming substrate section and the upstream section to the weight of the aerosol-generating article may less than or equal to 0.45.

The ratio of the combined weight of the aerosol-forming substrate section and the upstream section to the weight of the aerosol-generating article may be between 0.4 and 0.9. The ratio of the combined weight of the aerosol-forming substrate section and the upstream section to the weight of the aerosol-generating article may be between 0.45 and 0.9. The ratio of the combined weight of the aerosol-forming substrate section and the upstream section to the weight of the aerosol-generating article may be between 0.45 and 0.85. The ratio of the combined weight of the aerosol-forming substrate section and the upstream section to the weight of the aerosol-generating article may be between 0.5 and 0.85. The ratio of the combined weight of the aerosol-forming substrate section and the upstream section to the weight of the aerosol-generating article may be between 0.5 and 0.8. The ratio of the combined weight of the aerosol-forming substrate section and the upstream section to the weight of the aerosol-generating article may be between 0.55 and 0.8. The ratio of the combined weight of the aerosol-forming substrate section and the upstream section to the weight of the aerosol-generating article may be between 0.55 and 0.75. The ratio of the combined weight of the aerosol-forming substrate section and the upstream section to the weight of the aerosol-generating article may be between 0.6 and 0.75. The ratio of the combined weight of the aerosol-forming substrate section and the upstream section to the weight of the aerosol-generating article may be between 0.6 and 0.7. The ratio of the combined weight of the aerosol-forming substrate section and the upstream section to the weight of the aerosol-generating article may be between 0.65 and 0.7.

The upstream element may be formed from a material having a density of at least 100 milligrams per cubic centimetre. The upstream element may be formed from a material having a density of at least 120 milligrams per cubic centimetre. The upstream element may be formed from a material having a density of at least 140 milligrams per cubic centimetre. The upstream element may be formed from a material having a density of at least 160 milligrams per cubic centimetre. The upstream element may be formed from a material having a density of at least 180 milligrams per cubic centimetre. The upstream element may be formed from a material having a density of at least 200 milligrams per cubic centimetre.

The upstream element may be formed from a material having a density of less than or equal to 240 milligrams per cubic centimetre. The upstream element may be formed from a material having a density of less than or equal to 220 milligrams per cubic centimetre. The upstream element may be formed from a material having a density of less than or equal to 200 milligrams per cubic centimetre. The upstream element may be formed from a material having a density of less than or equal to 180 milligrams per cubic centimetre. The upstream element may be formed from a material having a density of less than or equal to 160 milligrams per cubic centimetre. The upstream element may be formed from a material having a density of less than or equal to 140 milligrams per cubic centimetre. The upstream element may be formed from a material having a density of less than or equal to 120 milligrams per cubic centimetre. The upstream element may be formed from a material having a density of less than or equal to 100 milligrams per cubic centimetre.

The upstream element may be formed from a material having a density of between 100 milligrams per cubic centimetre and 240 milligrams per cubic centimetre.

The upstream element may be formed from a material having a density of between 100 milligrams per cubic centimetre and 220 milligrams per cubic centimetre. The upstream element may be formed from a material having a density of between 100 milligrams per cubic centimetre and 200 milligrams per cubic centimetre. The upstream element may be formed from a material having a density of between 120 milligrams per cubic centimetre and 200 milligrams per cubic centimetre. The upstream element may be formed from a material having a density of between 120 milligrams per cubic centimetre and 180 milligrams per cubic centimetre. The upstream element may be formed from a material having a density of between 140 milligrams per cubic centimetre and 180 milligrams per cubic centimetre.

The heating chamber may extend between a distal end and a mouth, or proximal, end. The distal end of the heating chamber may be a closed end and the mouth, or proximal, end of the heating chamber may be an open end. An aerosol-generating article may be inserted into the heating chamber via the open end of the heating chamber. The heating chamber may be cylindrical in shape so as to conform to the same shape of an aerosol-generating article.

The expression “received within” may refer to the fact that a component or element is fully or partially received within another component or element. For example, the expression “aerosol-generating article is received within the heating chamber” refers to the aerosol-generating article being fully or partially received within the heating chamber of the aerosol-generating article. When the aerosol-generating article is received within the heating chamber, the aerosol-generating article may abut the distal end of the heating chamber. When the aerosol-generating article is received within the heating chamber, the aerosol-generating article may be in substantial proximity to the distal end of the heating chamber. The distal end of the heating chamber may be defined by an end-wall.

The length of the heating chamber may be between 10 millimetres and 50 millimetres. The length of the heating chamber may be between 20 millimetres and 40 millimetres. The length of the heating chamber may be between 25 millimetres and 30 millimetres.

The length of the heating chamber may be the same as or greater than the length of the aerosol-forming substrate section. The length of the heating chamber may be the same as or greater than the combined length of the upstream section or element and rod of aerosol-forming substrate section. Preferably, the length of the heating chamber is such that at least 75 percent of the length of the aerosol-forming substrate section is inserted or received within the heating chamber, when the aerosol-generating article is received with the aerosol-generating device. More preferably, the length of the heating chamber is such that at least 80 percent of the length of the aerosol-forming substrate section is inserted or received within the heating chamber, when the aerosol-generating article is received with the aerosol-generating device. More preferably, the length of the heating chamber is such that at least 90 percent of the length of the aerosol-forming substrate section is inserted or received within the heating chamber, when the aerosol-generating article is received with the aerosol-generating device. This maximises the length of the aerosol-forming substrate section along which the aerosol-forming substrate can be heated during use, thereby optimising the generation of aerosol from the aerosol-forming substrate and reducing tobacco waste.

The length of the heating chamber may be such that the downstream section or a portion thereof is configured to protrude from the heating chamber, when the aerosol-generating article received within the heating chamber. The length of the heating chamber may be such that a portion of the downstream section (such as the hollow tubular cooling element or downstream filter segment) is configured to protrude from the heating chamber, when the aerosol-generating article received within the heating chamber. The length of the heating chamber may be such that a portion of the downstream section (such as the hollow tubular cooling element or downstream filter segment) is configured to be received within the heating chamber, when the aerosol-generating article received within the heating chamber.

At least 25 percent of the length of the downstream section may be inserted or received within the heating chamber, when the aerosol-generating article is received within the device. At least 30 percent of the length of the downstream section may be inserted or received within the heating chamber, when the aerosol-generating article is received within the device.

At least 30 percent of the length of the hollow tubular element may be inserted or received within the heating chamber, when the aerosol-generating article is received within the device. At least 40 percent of the length of the hollow tubular element may be inserted or received within the heating chamber, when the aerosol-generating article is received within the device. At least 50 percent of the length of the hollow tubular element may be inserted or received within the heating chamber, when the aerosol-generating article is received within the device. Various lengths of the hollow tubular element are described in more detail within the present disclosure.

Optimising the amount or length of the article that is inserted into the aerosol-generating device may enhance the article's resistance to inadvertently falling out during use. Particularly, during the heating of the aerosol-forming substrate, the substrate may shrink such that its external diameter may have reduced, thereby reducing the extent to which the inserted portion of the article inserted into the device can frictionally engage with the heating chamber. The inserted portion of the article, or the portion of the article configured to be received within the heating chamber, may be the same length as the heating chamber.

The length of the heating chamber may be between 15 millimetres and 80 millimetres. Preferably, the length of the heating chamber is between 20 millimetres and 70 millimetres. More preferably, the length of the heating chamber is between 25 millimetres and 60 millimetres. More preferably, the length of the device is between 25 millimetres and 50 millimetres.

The length of the heating chamber may be between 25 millimetres and 29 millimetres. Preferably, the length of the heating chamber is between 25 millimetres and 29 millimetres. More preferably, the length of the heating chamber is between 26 millimetres and 29 millimetres. Even more preferably, the length of the heating chamber is 27 millimetres or 28 millimetres.

A diameter of the heating chamber may be between 4 millimetres and 10 millimetres. A diameter of the heating chamber may be between 5 millimetres and 9 millimetres. A diameter of the heating chamber may be between 6 millimetres and 8 millimetres. A diameter of the heating chamber may be between 6 millimetres and 7 millimetres.

A diameter of the heating chamber may be substantially the same as or greater than a diameter of the aerosol-generating article. A diameter of the heating chamber may be the same as a diameter of the aerosol-generating article in order to establish a tight fit with the aerosol-generating article.

The heating chamber may be configured to establish a tight fit with an aerosol-generating article received within the heating chamber. Tight fit may refer to a snug fit. The aerosol-generating device may comprise a peripheral wall. Such a peripheral wall may define the heating chamber, or heating chamber. The peripheral wall defining the heating chamber may be configured to engage with an aerosol-generating article received within the heating chamber in a tight fit manner, so that there is substantially no gap or empty space between the peripheral wall defining the heating chamber and the aerosol-generating article when received within the device.

Such a tight fit may establish an airtight fit or configuration between the heating chamber and an aerosol-generating article received therein.

With such an airtight configuration, there would be substantially no gap or empty space between the peripheral wall defining the heating chamber and the aerosol-generating article for air to flow through.

The tight fit with an aerosol-generating article may be established along the entire length of the heating chamber or along a portion of the length of the heating chamber.

The aerosol-generating device may comprise an air-flow channel extending between a channel inlet and a channel outlet. The air-flow channel may be configured to establish a fluid communication between the interior of the heating chamber and the exterior of the aerosol-generating device. The air-flow channel of the aerosol-generating device may be defined within the housing of the aerosol-generating device to enable fluid communication between the interior of the heating chamber and the exterior of the aerosol-generating device. When an aerosol-generating article is received within the heating chamber, the air-flow channel may be configured to provide air flow into the article in order to deliver generated aerosol to a user drawing from the mouth end of the article.

The air-flow channel of the aerosol-generating device may be defined within, or by, the peripheral wall of the housing of the aerosol-generating device. In other words, the air-flow channel of the aerosol-generating device may be defined within the thickness of the peripheral wall or by the inner surface of the peripheral wall, or a combination of both. The air-flow channel may partially be defined by the inner surface of the peripheral wall and may be partially defined within the thickness of the peripheral wall. The inner surface of the peripheral wall defines a peripheral boundary of the heating chamber.

The air-flow channel of the aerosol-generating device may extend from an inlet located at the mouth end, or proximal end, of the aerosol-generating device to an outlet located away from mouth end of the device. The air-flow channel may extend along a direction parallel to the longitudinal axis of the aerosol-generating device.

The heater may be any suitable type of heater. The heater may be an external heater.

The heater may externally heat the aerosol-generating article when received within the aerosol-generating device. Such an external heater may circumscribe the aerosol-generating article when inserted in or received within the aerosol-generating device.

In some embodiments, the heater is arranged to heat the outer surface of the aerosol-forming substrate. In some embodiments, the heater is arranged for insertion into an aerosol-forming substrate when the aerosol-forming substrate is received within the cavity. The heater may be positioned within the heating chamber, or heating chamber.

The heater may comprise at least one heating element. The at least one heating element may be any suitable type of heating element. In some embodiments, the device comprises only one heating element. In some embodiments, the device comprises a plurality of heating elements. The heater may comprise at least one resistive heating element. Preferably, the heater comprises a plurality of resistive heating elements. Preferably, the resistive heating elements are electrically connected in a parallel arrangement. Advantageously, providing a plurality of resistive heating elements electrically connected in a parallel arrangement may facilitate the delivery of a desired electrical power to the heater while reducing or minimising the voltage required to provide the desired electrical power. Advantageously, reducing or minimising the voltage required to operate the heater may facilitate reducing or minimising the physical size of the power supply.

Suitable materials for forming the at least one resistive heating element include but are not limited to: semiconductors such as doped ceramics, electrically ‘conductive’ ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese- and iron-containing alloys, and super-alloys based on nickel, iron, cobalt, stainless steel, Timetal® and iron-manganese-aluminium based alloys.

In some embodiments, the at least one resistive heating element comprises one or more stamped portions of electrically resistive material, such as stainless steel. Alternatively, the at least one resistive heating element may comprise a heating wire or filament, for example a Ni—Cr (Nickel-Chromium), platinum, tungsten or alloy wire.

In some embodiments, the at least one heating element comprises an electrically insulating substrate, wherein the at least one resistive heating element is provided on the electrically insulating substrate.

The electrically insulating substrate may comprise any suitable material. For example, the electrically insulating substrate may comprise one or more of: paper, glass, ceramic, anodized metal, coated metal, and Polyimide. The ceramic may comprise mica, Alumina (Al₂O₃) or Zirconia (ZrO₂). Preferably, the electrically insulating substrate has a thermal conductivity of less than or equal to about 40 Watts per metre Kelvin, preferably less than or equal to about 20 Watts per metre Kelvin and ideally less than or equal to about 2 Watts per metre Kelvin.

The heater may comprise a heating element comprising a rigid electrically insulating substrate with one or more electrically conductive tracks or wire disposed on its surface. The size and shape of the electrically insulating substrate may allow it to be inserted directly into an aerosol-forming substrate. If the electrically insulating substrate is not sufficiently rigid, the heating element may comprise a further reinforcement means. A current may be passed through the one or more electrically conductive tracks to heat the heating element and the aerosol-forming substrate.

In some embodiments, the heater comprises an inductive heating arrangement. The inductive heating arrangement may comprise an inductor coil and a power supply configured to provide high frequency oscillating current to the inductor coil. As used herein, a high frequency oscillating current means an oscillating current having a frequency of between about 500 KHz and about 30 MHz. The heater may advantageously comprise a DC/AC inverter for converting a DC current supplied by a DC power supply to the alternating current. The inductor coil may be arranged to generate a high frequency oscillating electromagnetic field on receiving a high frequency oscillating current from the power supply. The inductor coil may be arranged to generate a high frequency oscillating electromagnetic field in the heating chamber. In some embodiments, the inductor coil may substantially circumscribe the heating chamber. The inductor coil may extend at least partially along the length of the heating chamber.

The heater may comprise an inductive heating element. The inductive heating element may be a susceptor element. As used herein, the term ‘susceptor element’ refers to an element comprising a material that is capable of converting electromagnetic energy into heat. When a susceptor element is located in an alternating electromagnetic field, the susceptor is heated. Heating of the susceptor element may be the result of at least one of hysteresis losses and eddy currents induced in the susceptor, depending on the electrical and magnetic properties of the susceptor material.

A susceptor element may be arranged such that, when the aerosol-generating article is received in the cavity of the aerosol-generating device, the oscillating electromagnetic field generated by the inductor coil induces a current in the susceptor element, causing the susceptor element to heat up. In these embodiments, the aerosol-generating device is preferably capable of generating a fluctuating electromagnetic field having a magnetic field strength (H-field strength) of between 1 and 5 kilo amperes per metre (kA m), preferably between 2 and 3 kA/m, for example about 2.5 kA/m. The electrically-operated aerosol-generating device is preferably capable of generating a fluctuating electromagnetic field having a frequency of between 1 and 30 MHZ, for example between 1 and 10 MHz, for example between 5 and 7 MHz.

In these embodiments, the susceptor element is preferably located in contact with the aerosol-forming substrate. In some embodiments, a susceptor element is located in the aerosol-generating device. In these embodiments, the susceptor element may be located in the cavity. The aerosol-generating device may comprise only one susceptor element. The aerosol-generating device may comprise a plurality of susceptor elements. In some embodiments, the susceptor element is preferably arranged to heat the outer surface of the aerosol-forming substrate.

The susceptor element may comprise any suitable material. The susceptor element may be formed from any material that can be inductively heated to a temperature sufficient to release volatile compounds from the aerosol-forming substrate. Suitable materials for the elongate susceptor element include graphite, molybdenum, silicon carbide, stainless steels, niobium, aluminium, nickel, nickel containing compounds, titanium, and composites of metallic materials. Some susceptor elements comprise a metal or carbon. Advantageously the susceptor element may comprise or consist of a ferromagnetic material, for example, ferritic iron, a ferromagnetic alloy, such as ferromagnetic steel or stainless steel, ferromagnetic particles, and ferrite. A suitable susceptor element may be, or comprise, aluminium. The susceptor element preferably comprises more than about 5 percent, preferably more than 20 percent, more preferably more than 50 percent or more than 90 percent of ferromagnetic or paramagnetic materials. Some elongate susceptor elements may be heated to a temperature in excess of 250 degrees Celsius.

The susceptor element may comprise a non-metallic core with a metal layer disposed on the non-metallic core. For example, the susceptor element may comprise metallic tracks formed on an outer surface of a ceramic core or substrate.

In some embodiments the aerosol-generating device may comprise at least one resistive heating element and at least one inductive heating element. In some embodiments the aerosol-generating device may comprise a combination of resistive heating elements and inductive heating elements.

During use, the heater may be controlled to operate within a defined operating temperature range, below a maximum operating temperature. An operating temperature range between about 150 degrees Celsius and about 300 degrees Celsius in the heating chamber is preferable. The operating temperature range of the heater may be between about 150 degrees Celsius and about 250 degrees Celsius.

Preferably, the operating temperature range of the heater may be between about 150 degrees Celsius and about 200 degrees Celsius. More preferably, the operating temperature range of the heater may be between about 180 degrees Celsius and about 200 degrees Celsius. In particular, it has been found that optimal and consistent aerosol delivery may be achieved when using an aerosol-generating device having an external heater, which has an operating temperature range between about 180 degrees Celsius and about 200 degrees Celsius, with aerosol-generating articles having a relatively low RTD (for example, with a downstream section RTD of less than 15 millimetres H₂O), as mentioned in the present disclosure.

In embodiments where the aerosol-generating article comprises a ventilation zone at a location along the downstream section or the hollow tubular element, the ventilation zone may be arranged to be exposed when the aerosol-generating article is received within the heating chamber. Thus, the length of the heating chamber or heating chamber may be less than the distance of the upstream end of the aerosol-generating article to a ventilation zone located along the downstream section. In other words, when the aerosol-generating article is received within the aerosol-generating device, the distance between the ventilation zone and the upstream end of the upstream element may be greater than the length of the heating chamber.

When the article is received within the heating chamber, the ventilation zone may be located at least 0.5 millimetres away (in the downstream direction of the article) from the mouth end (or mouth end face) of the heating chamber or device itself. When the article is received within the heating chamber, the ventilation zone may be located at least 1 millimetre away (in the downstream direction of the article) from the mouth end (or mouth end face) of the heating chamber or device itself. When the article is received within the heating chamber, the ventilation zone may be located at least 2 millimetres away (in the downstream direction of the article) from the mouth end (or mouth end face) of the heating chamber or device itself.

Preferably, a ratio between the distance between the ventilation zone and the upstream end of the upstream element and a length of the heating chamber is from 1.03 to 1.13.

Such positioning of the ventilation zone ensures the ventilation zone is not occluded within the heating chamber itself, while also minimising the risk of occlusion by a user's lips or hands as the ventilation zone is located at the most upstream position from the downstream end of the article as reasonably possible without being occluded within the heating chamber.

The aerosol-generating device may comprise a power supply. The power supply may be a DC power supply. The power supply may be a battery. The power supply may be a nickel-metal hydride battery, a nickel cadmium battery, or a lithium based battery. For example, the battery may be a lithium-cobalt battery, a lithium-iron-phosphate battery or a lithium-polymer battery. In some examples, the power supply may be another form of charge storage device, such as a capacitor. The power supply may require recharging and may have a capacity that allows for the storage of enough energy for one or more user operations, for example one or more aerosol-generating experiences. For example, the power supply may have sufficient capacity to allow for continuous heating of an aerosol-forming substrate for a period of around six minutes, corresponding to the typical time taken to smoke a conventional cigarette, or for a period that is a multiple of six minutes. In another example, the power supply may have sufficient capacity to allow for a predetermined number of puffs or discrete activations of the heater.

Any one or more of the features of one example, embodiment, or aspect described herein may be combined with any one or more features of another example, embodiment, or aspect described herein. Below, there is provided a non-exhaustive list of non-limiting examples.

Below, there is provided a non-exhaustive list of non-limiting examples. Any one or more of the features of these examples may be combined with any one or more features of another example, embodiment, or aspect described herein.

EX1. An aerosol-generating article comprising: an aerosol-forming substrate section containing an aerosol-forming substrate; and a downstream section provided at a downstream end of the aerosol-forming substrate section, the downstream section comprising one or more hollow tubular elements, the downstream section having a length of at least 25 millimetres, wherein a ratio of the weight of the downstream section to the weight of the aerosol-forming substrate is less than or equal to 1.

EX2. An aerosol-generating article according to example EX1, wherein a ratio of the weight of the downstream section to the weight of the aerosol-forming substrate is less than or equal to 0.95.

EX3. An aerosol-generating article according to any preceding example, wherein a ratio of the weight of the downstream section to the weight of the aerosol-forming substrate is less than or equal to 0.9.

EX4. An aerosol-generating article according to any preceding example, wherein a ratio of the weight of the downstream section to the weight of the aerosol-forming substrate is less than or equal to 0.85.

EX5. An aerosol-generating article according to any preceding example, wherein a ratio of the weight of the downstream section to the weight of the aerosol-forming substrate is less than or equal to 0.82.

EX6. An aerosol-generating article according to any preceding example, wherein a ratio of the weight of the downstream section to the weight of the aerosol-forming substrate is less than or equal to 0.8.

EX7. An aerosol-generating article according to any preceding example, wherein the ratio of the weight of the aerosol-forming substrate to the weight of the aerosol-generating article is at least 0.45.

EX 8. An aerosol-generating article according to any preceding example, wherein the ratio of the weight of the aerosol-forming substrate to the weight of the aerosol-generating article is at least 0.55.

EX9. An aerosol-generating article according to any preceding example, wherein the ratio of the weight of the aerosol-forming substrate to the weight of the aerosol-generating article is at least 0.65.

EX10. An aerosol-generating article according to any preceding example, wherein the ratio of the weight of the aerosol-forming substrate to the weight of the aerosol-generating article is at least 0.75.

EX11. An aerosol-generating article according to example EX1, wherein the ratio of the weight of the aerosol-forming substrate to the weight of the aerosol-generating article is less than or equal to 0.9.

EX12. An aerosol-generating article according to example EX1, wherein the ratio of the weight of the aerosol-forming substrate to the weight of the aerosol-generating article is less than or equal to 0.85.

EX13. An aerosol-generating article according to example EX1, wherein the ratio of the weight of the aerosol-forming substrate to the weight of the aerosol-generating article is less than or equal to 0.8.

EX14. An aerosol-generating article according to any preceding example, wherein the aerosol-generating article has a length of less than or equal to 60 millimetres.

EX15. An aerosol-generating article according to any preceding example, wherein the aerosol-generating article has a length of less than or equal to 50 millimetres.

EX16. An aerosol-generating article according to any preceding example, wherein the aerosol-generating article has a length of less than or equal to 45 millimetres.

EX17. An aerosol-generating article according to any preceding example, wherein the one or more tubular elements comprises a hollow tubular element abutting a downstream end of the aerosol-forming substrate section.

EX18. An aerosol-generating article according to example EX17, wherein the hollow tubular element has a length of between 6 millimetres and 25 millimetres.

EX19. An aerosol-generating article according to example EX17 or example EX18, wherein the hollow tubular element has an internal volume of at least 260 cubic millimetres.

EX20. An aerosol-generating article according to any of examples EX17 to EX19, wherein the hollow tubular element has a weight of less than or equal to 150 milligrams.

EX21. An aerosol-generating article according to any of examples EX17 to EX20, wherein the hollow tubular element has weight of between 40 milligrams and 150 milligrams.

EX22. An aerosol-generating article according to any of examples EX17 to EX21, wherein the hollow tubular element has a wall thickness of less than or equal to 1500 micrometres.

EX23. An aerosol-generating article according to any of examples EX17 to EX22, wherein the hollow tubular element has a wall thickness of between 500 micrometres and 1500 micrometres.

EX24. An aerosol-generating article according to any of examples EX17 to EX23, wherein the hollow tubular element is formed from a material having a grammage of less than or equal to 80 gsm.

EX25. An aerosol-generating article according to any of examples EX17 to EX24, wherein the hollow tubular element is formed from a material having a grammage of between 60 gsm and 80 gsm.

EX26. An aerosol-generating article according to any preceding example, wherein the one or more tubular elements comprises a second hollow tubular element abutting a downstream end of a first hollow tubular element.

EX27. An aerosol-generating article according to example EX26, wherein the second hollow tubular element has a length of between 6 millimetres and 20 millimetres.

EX28. An aerosol-generating article according to example EX26 or example EX27, wherein the second hollow tubular element has an internal volume of at least 260 cubic millimetres.

EX29. An aerosol-generating article according to any of examples EX26 to EX28, wherein the second hollow tubular element has a weight of less than or equal to 80 milligrams.

EX30. An aerosol-generating article according to any of examples EX26 to EX29, wherein the second hollow tubular element has weight of between 40 milligrams and 80 milligrams.

EX31. An aerosol-generating article according to any of examples EX26 to EX30, wherein the second hollow tubular element has a wall thickness of less than or equal to 1500 micrometres.

EX32. An aerosol-generating article according to any of examples EX26 to EX31, wherein the second hollow tubular element has a wall thickness of between 200 micrometres and 1500 micrometres.

EX33. An aerosol-generating article according to any of examples EX26 to EX32, wherein the second hollow tubular element is formed from a material having a density of less than or equal to 400 milligrams per cubic centimetre.

EX34. An aerosol-generating article according to any of examples EX26 to EX33, wherein the second hollow tubular element is formed from a material having a density of between 200 milligrams per cubic centimetre and 400 milligrams per cubic centimetre.

EX35. An aerosol-generating article according to any of examples EX26 to EX34, wherein the second hollow tubular element is formed from one or more materials selected from the group consisting of: cellulose acetate; cardboard; crimped paper, such as crimped heat resistant paper or crimped parchment paper; and polymeric materials, such as low density polyethylene (LDPE).

EX36. An aerosol-generating article according to any preceding example, wherein the one or more hollow tubular elements have a combined internal volume of at least 260 cubic millimetres.

EX37. An aerosol-generating article according to any preceding example, wherein the one or more hollow tubular elements have a combined internal volume of at least 300 cubic millimetres.

EX38. An aerosol-generating article according to any preceding example, wherein the one or more hollow tubular elements have a combined internal volume of at least 500 cubic millimetres.

EX39. An aerosol-generating article according to any preceding example, wherein the one or more hollow tubular elements have a combined internal volume of at least 700 cubic millimetres.

EX40. An aerosol-generating article according to any preceding example, wherein the downstream section comprises a downstream filter segment.

EX41. An aerosol-generating article according to example EX40, wherein the downstream filter segment comprises at least one filter segment formed of a fibrous filtration material.

EX42. An aerosol-generating article according to example EX40, wherein the downstream filter segment comprises at least one filter segment formed of cardboard.

EX43. An aerosol-generating article according to any of examples EX40 to EX42, wherein the downstream filter segment has a length of between 3 millimetres and 11 millimetres.

EX44. An aerosol-generating article according to any of examples EX40 to EX43, wherein the downstream filter segment has a resistance to draw (RTD) of between 4 mm H₂O and 11 mmH₂O.

EX45. An aerosol-generating article according to any of examples EX40 to EX43, wherein the downstream filter segment is formed from a material having a density of less than or equal to 400 milligrams per cubic centimetre.

EX46. An aerosol-generating article according to any of examples EX40 to EX45, wherein the downstream filter segment is formed from a material having a density of between 200 milligrams per cubic centimetre and 400 milligrams per cubic centimetre.

EX47. An aerosol-generating article according to any of examples EX40 to EX46, wherein the first hollow tubular element and the downstream filter segment have a combined length of between 24 millimetres and 32 millimetres.

EX48. An aerosol-generating article according to any of examples EX40 to EX47, wherein the downstream filter segment has a weight of less than or equal to 70 milligrams.

EX49. An aerosol-generating article according to any of examples EX40 to EX48, wherein the downstream filter segment has weight of between 50 milligrams and 70 milligrams.

EX50. An aerosol-generating article according to any of examples EX40 to EX49, wherein the downstream section comprises a downstream tubular element abutting a downstream end of the downstream filter segment.

EX51. An aerosol-generating article according to example EX50, wherein the downstream tubular element is a third hollow tubular element.

EX52. An aerosol-generating article according to example EX50 or example EX51, wherein the downstream tubular element has a weight of less than or equal to 500 milligrams.

EX53. An aerosol-generating article according to any of examples EX50 to EX52, wherein the downstream tubular element has weight of between 50 milligrams and 500 milligrams.

EX54. An aerosol-generating article according to any of examples EX50 to EX53, wherein the downstream tubular element has a length of between 3 millimetres and 20 millimetres.

EX55. An aerosol-generating article according to any of examples EX50 to EX54, wherein the downstream tubular element has a resistance to draw (RTD) of between 1 mmH₂O and 10 mmH₂O.

EX56. An aerosol-generating article according to any of examples EX50 to EX55, wherein the downstream tubular element is formed from a material having a density of less than or equal to 240 milligrams per cubic centimetre.

EX57. An aerosol-generating article according to any of examples EX50 to EX56, wherein the downstream tubular element is formed from a material having a density of between 100 milligrams per cubic centimetre and 240 milligrams per cubic centimetre.

EX58. An aerosol-generating article according to any of examples EX50 to EX57, wherein the downstream tubular element is formed from cellulose acetate tow.

EX59. An aerosol-generating article according to any preceding example, wherein the downstream section has a weight of less than or equal to 300 milligrams.

EX60. An aerosol-generating article according to any preceding example, wherein the downstream section has weight of between 120 milligrams and 300 milligrams.

EX61. An aerosol-generating article according to any preceding example, wherein a ratio of the weight of the downstream section to the weight of the aerosol-generating article is less than or equal to 0.45.

EX62. An aerosol-generating article according to any preceding example, wherein the downstream section has a length of at least 18 millimetres.

EX63. An aerosol-generating article according to any preceding example, wherein the downstream section has a length of between 18 millimetres and 40 millimetres.

EX64. An aerosol-generating article according to any preceding example, wherein the downstream section has a resistance to draw (RTD) of less than 20 mm H₂O.

EX65. An aerosol-generating article according to any preceding example, wherein the downstream section has a resistance to draw (RTD) of less than 1 mm H₂O.

EX66. An aerosol-generating article according to any preceding example, wherein the downstream section has a resistance to draw (RTD) of less than 0.01 mm H₂O.

EX67. An aerosol-generating article according to any preceding example, comprising an upstream section provided at an upstream end of the aerosol-forming substrate section, the upstream section comprising an upstream element.

EX68. An aerosol-generating article according to example EX67, wherein the upstream element has a length of between 2 millimetres and 8 millimetres.

EX69. An aerosol-generating article according to example EX67 or example EX68, wherein the upstream element is formed of a hollow tubular segment defining a longitudinal cavity providing an unrestricted flow channel.

EX70. An aerosol-generating article according to example EX69, wherein the longitudinal cavity of the hollow tubular segment has a diameter of at least 5 millimetres.

EX71. An aerosol-generating article according to example EX69 or example EX70, wherein the hollow tubular segment has a wall thickness of less than 1 millimetre.

EX72. An aerosol-generating article according to any of examples EX67 to EX71, wherein the upstream element has a resistance to draw (RTD) of less than 2 mm H₂O.

EX73. An aerosol-generating article according to any of examples EX67 to EX72, wherein an upstream end of the upstream element defines an upstream end of the aerosol-generating article.

EX74. An aerosol-generating article according to any of examples EX67 to EX73, wherein the upstream element has a weight of less than or equal to 70 milligrams.

EX75. An aerosol-generating article according to any of examples EX67 to EX74, wherein the upstream element has weight of between 50 milligrams and 70 milligrams.

EX76. An aerosol-generating article according to any of examples EX67 to EX75, wherein a ratio of the combined weight of the aerosol-forming substrate section and the upstream section to the weight of the aerosol-generating article is at least 0.4.

EX77. An aerosol-generating article according to any of examples EX67 to EX76, wherein a ratio of the combined weight of the aerosol-forming substrate section and the upstream section to the weight of the aerosol-generating article is at least 0.5.

EX78. An aerosol-generating article according to any of examples EX67 to EX77, wherein a ratio of the combined weight of the aerosol-forming substrate section and the upstream section to the weight of the aerosol-generating article is at least 0.6.

EX79. An aerosol-generating article according to any of examples EX67 to EX78, wherein a ratio of the combined weight of the aerosol-forming substrate section and the upstream section to the weight of the aerosol-generating article is at least 0.7.

EX80. An aerosol-generating article according to any of examples EX67 to EX79, wherein a ratio of the combined weight of the aerosol-forming substrate section and the upstream section to the weight of the aerosol-generating article is at least 0.8.

EX81. An aerosol-generating article according to any preceding example, wherein the aerosol-generating article has a resistance to draw (RTD) of between 20 mm H₂O and 22 mm H₂O.

EX82. An aerosol-generating article according to any preceding example, wherein the aerosol-generating article has an external diameter of at least 5 millimetres.

EX83. An aerosol-generating article according to any preceding example, wherein the aerosol-generating article has an external diameter of less than or equal to about 12 millimetres.

EX84. An aerosol-generating article according to any preceding example, wherein the external diameter of the aerosol-generating article is substantially uniform along its length.

EX85. An aerosol-generating article according to any preceding example, wherein the aerosol-generating article has a weight of less than or equal to 700 milligrams.

EX86. An aerosol-generating article according to any preceding example, wherein the aerosol-generating article has weight of between 350 milligrams and 700 milligrams.

EX87. An aerosol-generating article according to any preceding example, wherein the aerosol-forming substrate comprises a rod of aerosol-forming substrate.

EX88. An aerosol-generating article according to example EX87, wherein the rod of aerosol-forming substrate comprises a substantially solid cylinder.

EX89. An aerosol-generating article according to any preceding example, comprising a wrapper circumscribing at least the aerosol-forming substrate section.

EX90. An aerosol-generating article according to example EX89, wherein the wrapper is a paper wrapper.

EX91. An aerosol-generating article according to example EX89 or example EX90, wherein the wrapper has a grammage of between 15 gsm and 35 gsm.

EX92. An aerosol-generating article according to any of examples EX89 to EX91, wherein the wrapper has a thickness of between 25 micrometres and 55 micrometres.

EX93. An aerosol-generating article according to any preceding example, comprising one or more susceptor elements.

EX94. An aerosol-generating article according to example EX90, wherein the one or more susceptor elements are provided in the aerosol-forming substrate section.

EX95. An aerosol-generating article according to any preceding example, wherein a ratio of the weight of the aerosol-forming substrate section to the weight of the aerosol-generating article is at least 0.4.

EX96. An aerosol-generating article according to any preceding example, wherein a ratio of the weight of the aerosol-forming substrate section to the weight of the aerosol-generating article is at least 0.5.

EX97. An aerosol-generating article according to any preceding example, wherein a ratio of the weight of the aerosol-forming substrate section to the weight of the aerosol-generating article is at least 0.6.

EX98. An aerosol-generating article according to any preceding example, wherein a ratio of the weight of the aerosol-forming substrate section to the weight of the aerosol-generating article is at least 0.7.

EX99. An aerosol-generating article according to any preceding example, wherein a ratio of the weight of the aerosol-forming substrate section to the weight of the aerosol-generating article is at least 0.8.

EX100. An aerosol-generating article according to any preceding example, wherein the aerosol-forming substrate section has a length of at least 8 millimetres.

EX101. An aerosol-generating article according to any preceding example, wherein the aerosol-forming substrate section has a length of between 8 millimetres and 25 millimetres.

EX102. An aerosol-generating article according to any preceding example, wherein the aerosol-forming substrate section has a length of between 13 millimetres and 25 millimetres.

EX103. An aerosol-generating article according to any preceding example, wherein the aerosol-forming substrate section has a resistance to draw (RTD) of between 4 mmH₂O and 10 mm H₂O.

EX104. An aerosol-generating article according to any preceding example, wherein the aerosol-forming substrate section has weight of at least 200 milligrams.

EX105. An aerosol-generating article according to any preceding example, wherein the aerosol-forming substrate section has a weight of between 200 milligrams and 400 milligrams.

EX106. An aerosol-generating article according to any preceding example, wherein the aerosol-forming substrate comprises one or more aerosol formers.

EX107. An aerosol-generating article according to any preceding example, wherein the aerosol-forming substrate has an aerosol former content of at least 10 percent by weight, on a dry weight basis.

EX108. An aerosol-generating article according to any preceding example, wherein the aerosol-forming substrate has an aerosol former content of between 10 percent and 20 percent by weight, on a dry weight basis.

EX109. An aerosol-generating article according to any preceding example, wherein the aerosol-forming substrate has an aerosol former content of between 50 percent and 80 percent by weight, on a dry weight basis.

EX110. An aerosol-generating article according to any of examples EX106 to EX109, wherein the one or more aerosol formers comprise one or more of glycerine and propylene glycol.

EX111. An aerosol-generating article according to any preceding example, wherein the aerosol-forming substrate has a weight of at least 200 milligrams.

EX112. An aerosol-generating article according to any preceding example, wherein the aerosol-forming substrate has a weight of between 200 milligrams and 400 milligrams.

EX113. An aerosol-generating article according to any preceding example, wherein the aerosol-forming substrate comprises a shredded tobacco material.

EX114. An aerosol-generating article according to example EX113, wherein the shredded tobacco material has a bulk density of at least 100 milligrams per cubic centimetre.

EX115. An aerosol-generating article according to example EX113 or example EX114, wherein the shredded tobacco material has a bulk density of at least 200 milligrams per cubic centimetre.

EX116. An aerosol-generating article according to any of examples EX113 to EX115, wherein the shredded tobacco material has a bulk density of at least 300 milligrams per cubic centimetre.

EX117. An aerosol-generating article according to any of any of examples EX113 to EX116, wherein the shredded tobacco material has a weight of at least 200 milligrams.

EX118. An aerosol-generating article according to any of examples EX113 to EX117, wherein the shredded tobacco material has a weight of between 200 milligrams and 300 milligrams.

EX119. An aerosol-generating article according to any of examples EX113 to EX118, wherein a ratio of the weight of shredded tobacco material to the weight of the aerosol-generating article is at least 0.45.

EX120. An aerosol-generating article according to any of examples EX113 to EX119, wherein a ratio of the weight of shredded tobacco material to the weight of the aerosol-generating article is at least 0.5.

EX121. An aerosol-generating article according to any of examples EX113 to EX120, wherein a ratio of the weight of shredded tobacco material to the weight of the aerosol-generating article is at least 0.55.

EX122. An aerosol-generating article according to any of examples EX113 to EX121, wherein a ratio of the weight of shredded tobacco material to the weight of the aerosol-generating article is at least 0.6.

EX123. An aerosol-generating article according to any of examples EX113 to EX122, wherein a ratio of the weight of shredded tobacco material to the weight of the aerosol-generating article is at least 0.65.

EX124. An aerosol-generating article according to any of examples EX113 to EX123, wherein a ratio of the weight of shredded tobacco material to the weight of the aerosol-generating article is at least 0.7.

EX125. An aerosol-generating article according to any of examples EX113 to EX124, wherein a ratio of the weight of shredded tobacco material to the weight of the aerosol-generating article is at least 0.75.

EX126. An aerosol-generating article according to any of examples EX113 to EX125, wherein a ratio of the weight of shredded tobacco material to the weight of the aerosol-generating article is at least 0.8.

EX127. An aerosol-generating article according to any of examples EX113 to EX126, wherein a ratio of the weight of shredded tobacco material to the weight of the aerosol-generating article is at least 0.85.

EX128. An aerosol-generating article according to any of examples EX113 to EX127, wherein a ratio of the weight of shredded tobacco material to the weight of the aerosol-generating article is at least 0.9.

EX129. An aerosol-generating article according to any of examples EX113 to EX127, wherein a ratio of the weight of shredded tobacco material to the weight of the aerosol-generating article is less than or equal to 0.9.

EX130. An aerosol-generating article according to any of examples EX113 to EX127, wherein a ratio of the weight of shredded tobacco material to the weight of the aerosol-generating article is less than or equal to 0.85.

EX131. An aerosol-generating article according to any of examples EX113 to EX127, wherein a ratio of the weight of shredded tobacco material to the weight of the aerosol-generating article is less than or equal to 0.8.

EX132. An aerosol-generating article according to any preceding example, wherein a ratio of the length of the aerosol-forming substrate section to the length of the aerosol-generating article is at least 0.3.

EX133. An aerosol-generating article according to any preceding example, wherein a ratio of the length of the aerosol-forming substrate section to the length of the aerosol-generating article is at least 0.35.

EX134. An aerosol-generating article according to any preceding example, wherein a ratio of the length of the aerosol-forming substrate section to the length of the aerosol-generating article is at least 0.37.

EX135. An aerosol-generating article according to any preceding example, comprising a ventilation zone.

EX136. An aerosol-generating article according to example EX135, wherein the ventilation zone is provided at a location along the downstream section.

EX137. An aerosol-generating article according to example EX135, wherein the ventilation zone is provided at a location along the first hollow tubular element.

EX138. An aerosol-generating article according to example EX135, wherein the ventilation zone is provided at a distance of between 26 millimetres and 33 millimetres from an upstream end of the aerosol-generating article.

EX139. An aerosol-generating article according to any of examples EX135 to EX138, wherein a ventilation level of the aerosol-generating article is between 10 percent and 30 percent.

EX140. An aerosol-generating article according to any of examples EX135 to EX139, wherein a ventilation level of the aerosol-generating article is between 12 percent and 25 percent.

EX141. An aerosol-generating system comprising:
an aerosol-generating article according to any one of examples 1 to 140; and
an aerosol-generating device comprising:
a heating chamber for receiving the aerosol-generating article; and
at least a heating element provided at or about the periphery of the heating chamber.

In the following, the invention will be further described with reference to the drawings of the accompanying Figures, wherein:

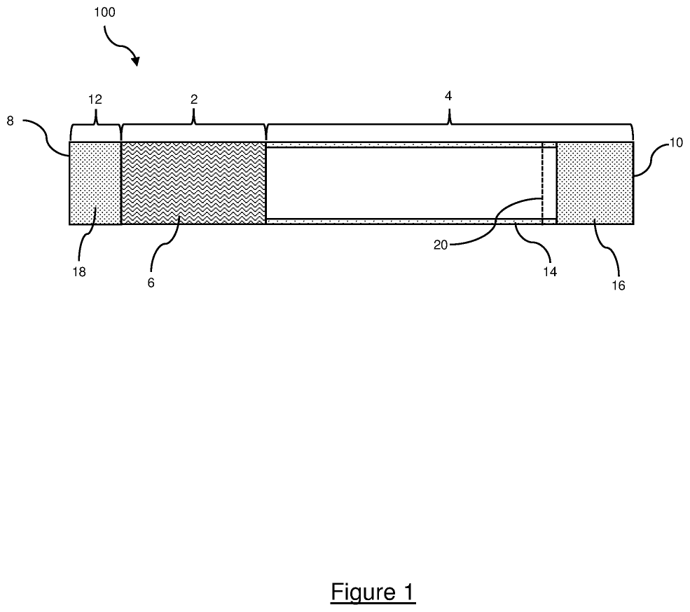

FIG. 1 shows a schematic side sectional view of an aerosol-generating article;

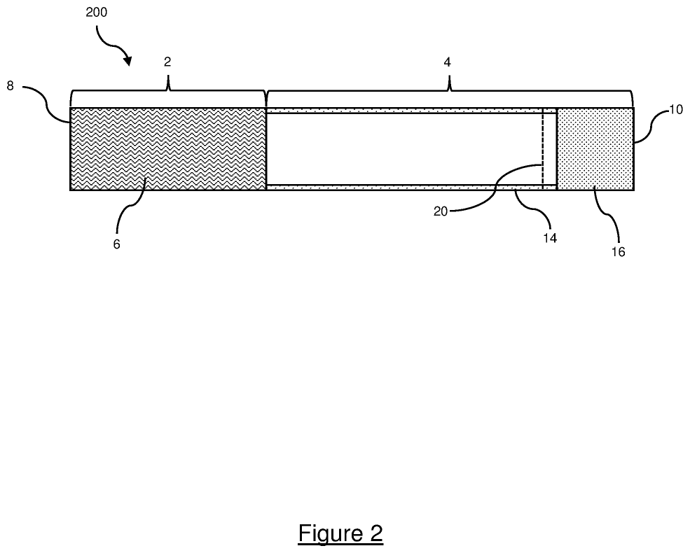

FIG. 2 shows a schematic side sectional view of an aerosol-generating article in accordance with the present disclosure;

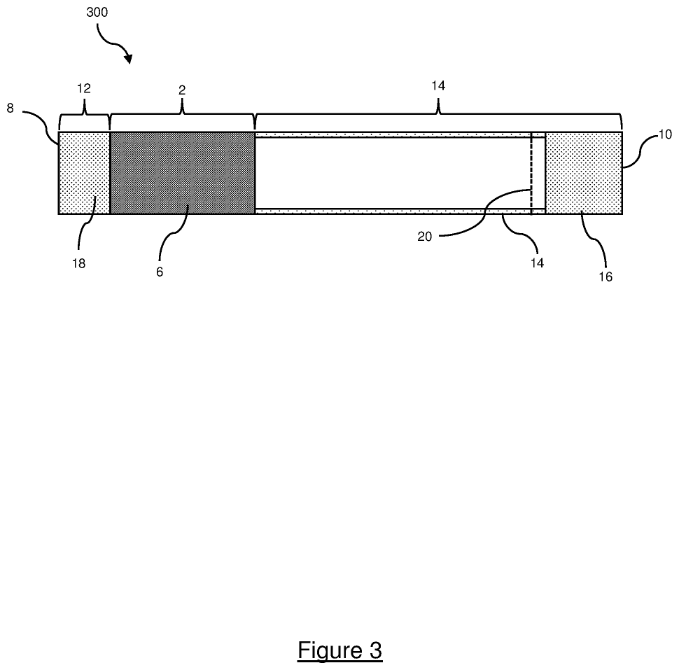

FIG. 3 shows a schematic side sectional view of an aerosol-generating article in accordance with the present disclosure;

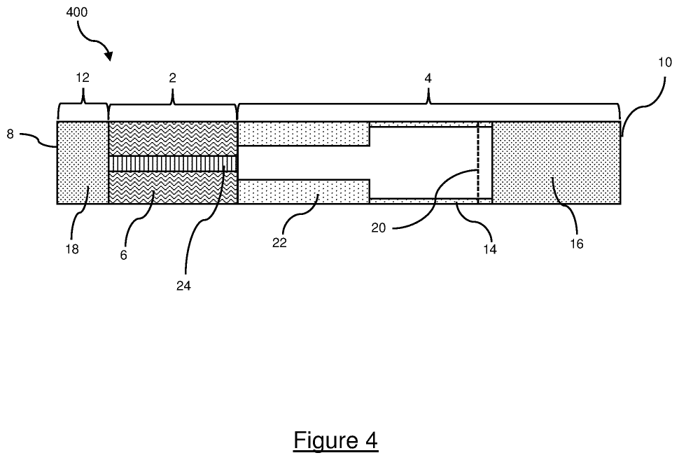

FIG. 4 shows a schematic side sectional view of an aerosol-generating article;

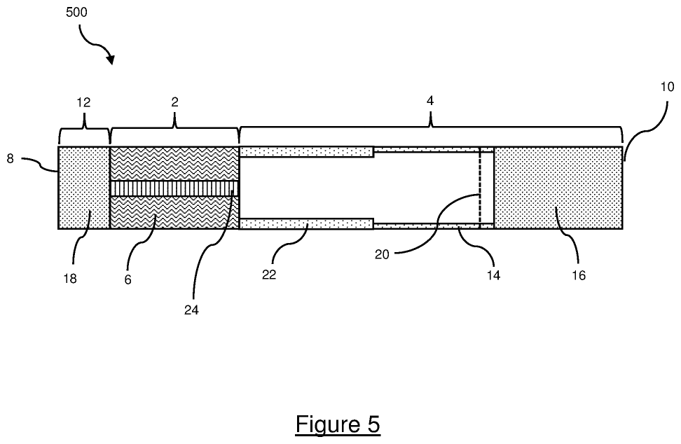

FIG. 5 shows a schematic side sectional view of an aerosol-generating article in accordance with the present disclosure;

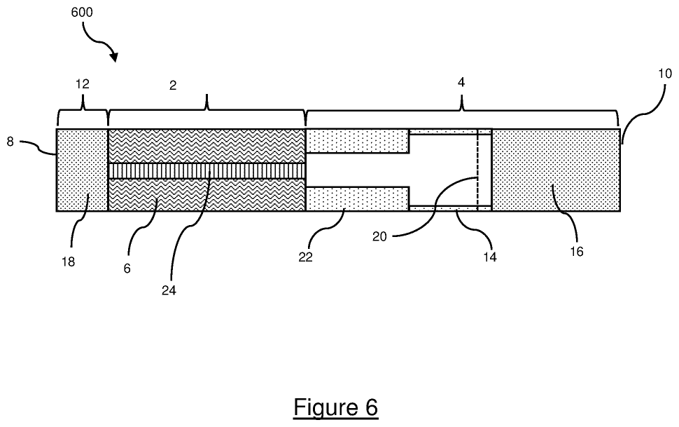

FIG. 6 shows a schematic side sectional view of an aerosol-generating article in accordance with the present disclosure;

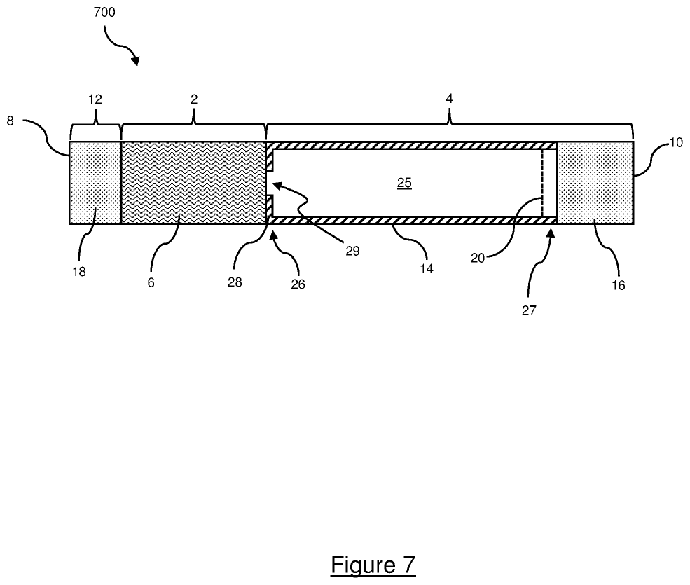

FIG. 7 shows a schematic side sectional view of an aerosol-generating article in accordance with the present disclosure; and

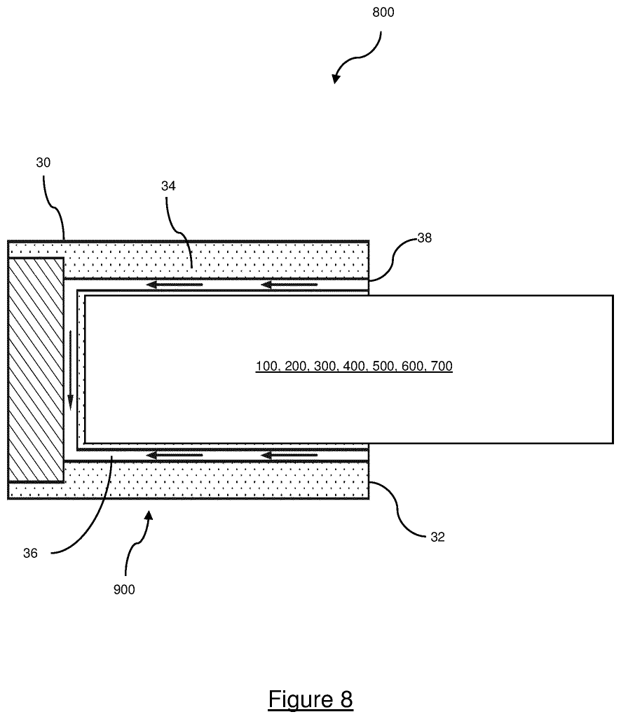

FIG. 8 shows a schematic side sectional view of an aerosol-generating system in accordance with the present disclosure.

Aerosol-generating articles 100, 200, 300, 400, 500, 600, 700 shown in all Figures of the present disclosure comprise an aerosol-forming substrate section 2 and a downstream section 4 located downstream of the aerosol-forming substrate section 2. The aerosol-forming substrate section 2 comprises an aerosol-forming substrate 6. In these examples, the aerosol-forming substrate 6 is a rod of aerosol-forming substrate. Aerosol-generating articles 100, 200, 300, 400, 500, 600, 700 extend from an upstream or distal end 8 to a downstream or mouth end 10. The downstream or mouth end 10 is defined by the downstream end of the downstream section 4.

Each of the components of the aerosol-generating articles 100, 200, 300, 400, 500, 600, 700 shown in the Figures and described in the present disclosure may be circumscribed by corresponding wrappers or may be joined together by one or more wrappers, which are not shown in the Figures.

The aerosol-forming substrate 6 is circumscribed by a wrapper (not shown), and comprises at least one of the types of aerosol-forming substrate described in the present disclosure, such as plant cut filler, particularly tobacco cut filler, homogenised tobacco, a gel formulation, an aerosol-generating film, or a homogenised plant material comprising particles of a plant other than tobacco.

The aerosol-generating articles 100, 200, 300, 400, 500, 600, 700 have an outer diameter of about 7.1 millimetres.

FIG. 1 shows an aerosol-generating article 100 having a downstream section 4 and an aerosol-forming substrate section 2. The downstream section 4 is located downstream of the aerosol-forming substrate section 2. In the example of FIG. 1, the aerosol-generating article 100 also includes an upstream section 12 located upstream of the aerosol-forming substrate section 2. The distal end 8 of the aerosol-generating article 100 is defined by an upstream end of the upstream section 12.

The downstream section 4 of the aerosol-generating article 100 shown in FIG. 1 includes one or more tubular elements. In the example of FIG. 1, the one or more tubular elements includes a hollow tubular element 14 and a downstream filter segment 16. The hollow tubular element 14 is located immediately downstream of the aerosol-forming substrate section 2. In other words, the hollow tubular element 14 abuts the downstream end of the aerosol-forming substrate section 2. The downstream filter segment 16 abuts the downstream end of the hollow tubular element 14. The hollow tubular element 14 is therefore located between the aerosol-forming substrate section 2 and the downstream filter segment 16. The downstream end 10 of the aerosol-generating article 100 is defined by a downstream end of the downstream filter segment 16.

In the example of FIG. 1, the length of the aerosol-forming substrate 6 in the aerosol-forming substrate section is about 17 millimetres.

The hollow tubular element 14 is provided in the form of a hollow cylindrical tube. In the example of FIG. 1, the hollow tubular element 14 may be formed from cardboard or cellulose acetate. The hollow tubular element 14 defines an internal cavity that extends all the way from an upstream end of the hollow tubular element 14 to a downstream end of the hollow tubular element 14. The internal cavity is substantially empty, and so substantially unrestricted airflow is enabled along the internal cavity. The hollow tubular element 14 may not substantially contribute to the overall RTD of the aerosol-generating article 100. In the example of FIG. 1, the length of the hollow tubular element 14 is about 21 millimetres, and the wall thickness of the hollow tubular element 14 is about 250 micrometres.

The downstream filter segment 16 is provided in the form of a cylindrical plug of cellulose acetate tow. In the example of FIG. 1, the length of the downstream filter segment 16 is about 7 millimetres.

The upstream section 12 includes an upstream element 18. The upstream element 18 abuts an upstream end of the aerosol-forming substrate section 2. The upstream element 18 is provided in the form of a cylindrical plug of cellulose acetate tow. In the example of FIG. 1, the length of the upstream element 18 is about 5 millimetres.

The aerosol-generating article 100 has a ventilation zone 20 provided at a location along the hollow tubular element 14. The ventilation zone 20 includes at least one circumferential row of perforations extending through a peripheral wall of the hollow tubular element 14 and any wrapper (not shown) circumscribing the hollow tubular element 14. The ventilation zone 20 is provided at distance of about 2 millimetres from the downstream end of the hollow tubular element 14.

In the example of FIG. 1, the aerosol-forming substrate has a bulk density of about 440 milligrams per cubic centimetre. The aerosol-generating article 100 has a weight of about 505 milligrams.

FIG. 2 shows an aerosol-generating article 200. The aerosol-generating article 200 has a downstream section 4 and an aerosol-forming substrate section 2. The downstream section 4 is located downstream of the aerosol-forming substrate section 2. In the example of FIG. 2, the aerosol-generating article 200 does not include an upstream section. The distal end 8 of the aerosol-generating article 200 is defined by an upstream end of the aerosol-forming substrate section 2.

The downstream section 4 of the aerosol-generating article 200 shown in FIG. 2 includes one or more tubular elements. In the example of FIG. 2, the one or more tubular elements includes a hollow tubular element 14 and a downstream filter segment 16. The hollow tubular element 14 is located immediately downstream of the aerosol-forming substrate section 2. In other words, the hollow tubular element 14 abuts the downstream end of the aerosol-forming substrate section 2. The downstream filter segment 16 abuts the downstream end of the hollow tubular element 14. The hollow tubular element 14 is therefore located between the aerosol-forming substrate section 2 and the downstream filter segment 16. The downstream end 10 of the aerosol-generating article 200 is defined by a downstream end of the downstream filter segment 16.

The hollow tubular element 14 is provided in the form of a hollow cylindrical tube. In the example of FIG. 2, the hollow tubular element 14 may be formed from cardboard or cellulose acetate. The hollow tubular element 14 defines an internal cavity that extends all the way from an upstream end of the hollow tubular element 14 to a downstream end of the hollow tubular element 14. The internal cavity is substantially empty, and so substantially unrestricted airflow is enabled along the internal cavity. The hollow tubular element 14 may not substantially contribute to the overall RTD of the aerosol-generating article 100. In the example of FIG. 2, the length of the hollow tubular element 14 is about 21 millimetres, and the wall thickness of the hollow tubular element 14 is about 250 micrometres.

The downstream filter segment 16 is provided in the form of a cylindrical plug of cellulose acetate tow. In the example of FIG. 2, the length of the downstream filter segment 16 is about 7 millimetres.

The aerosol-generating article 100 has a ventilation zone 20 provided at a location along the hollow tubular element 14. The ventilation zone 20 includes at least one circumferential row of perforations extending through a peripheral wall of the hollow tubular element 14 and any wrapper (not shown) circumscribing the hollow tubular element 14. The ventilation zone 20 is provided at distance of about 2 millimetres from the downstream end of the hollow tubular element 14.

The weight of the downstream section 4 in the aerosol-generating article 100 of FIG. 1 is about 273 milligrams.

In the example of FIG. 2, the length of the aerosol-forming substrate 6 in the aerosol-forming substrate section 2 is about 22 millimetres and the weight of the aerosol-generating article 200 is about 560 milligrams.

The aerosol-generating article 200 shown in FIG. 2 does not include an upstream element.

In the example of FIG. 2, the aerosol-forming substrate 6 has a weight of about 381 milligrams. The aerosol-generating article 200 has a weight of 560 milligrams. Consequently, with the aerosol-generating article 200 shown in FIG. 2, the ratio of the weight of the downstream section 4 to the weight of the aerosol-forming substrate 6 is 0.47.

FIG. 3 shows an aerosol-generating article 300. The aerosol-generating article 300 has a downstream section 4 and an aerosol-forming substrate section 2. The downstream section 4 is located downstream of the aerosol-forming substrate section 2. In the example of FIG. 3, the aerosol-generating article 300 also includes an upstream section 12 located upstream of the aerosol-forming substrate section 2. The distal end 8 of the aerosol-generating article 100 is defined by an upstream end of the upstream section 12.

The downstream section 4 of the aerosol-generating article 300 shown in FIG. 3 includes one or more tubular elements. In the example of FIG. 3, the one or more tubular elements includes a hollow tubular element 14 and a downstream filter segment 16. The hollow tubular element 14 is located immediately downstream of the aerosol-forming substrate section 2. In other words, the hollow tubular element 14 abuts the downstream end of the aerosol-forming substrate section 2. The downstream filter segment 16 abuts the downstream end of the hollow tubular element 14. The hollow tubular element 14 is therefore located between the aerosol-forming substrate section 2 and the downstream filter segment 16. The downstream end 10 of the aerosol-generating article 300 is defined by a downstream end of the downstream filter segment 16.

In the example of FIG. 3, the length of the aerosol-forming substrate 6 in the aerosol-forming substrate section is about 17 millimetres.

The hollow tubular element 14 is provided in the form of a hollow cylindrical tube. In the example of FIG. 3, the hollow tubular element 14 may be formed from cardboard or cellulose acetate. The hollow tubular element 14 defines an internal cavity that extends all the way from an upstream end of the hollow tubular element 14 to a downstream end of the hollow tubular element 14. The internal cavity is substantially empty, and so substantially unrestricted airflow is enabled along the internal cavity. The hollow tubular element 14 may not substantially contribute to the overall RTD of the aerosol-generating article 100. In the example of FIG. 3, the length of the hollow tubular element 14 is about 21 millimetres, and the wall thickness of the hollow tubular element 14 is about 250 micrometres.

The downstream filter segment 16 is provided in the form of a cylindrical plug of cellulose acetate tow. In the example of FIG. 3, the length of the downstream filter segment 16 is about 7 millimetres.

The upstream section 12 includes an upstream element 18. The upstream element 18 abuts an upstream end of the aerosol-forming substrate section 2. The upstream element 18 is provided in the form of a cylindrical plug of cellulose acetate tow. In the example of FIG. 3, the length of the upstream element 18 is about 5 millimetres.

The aerosol-generating article 300 has a ventilation zone 20 provided at a location along the hollow tubular element 14. The ventilation zone 20 includes at least one circumferential row of perforations extending through a peripheral wall of the hollow tubular element 14 and any wrapper (not shown) circumscribing the hollow tubular element 14. The ventilation zone 20 is provided at distance of about 2 millimetres from the downstream end of the hollow tubular element 14.

In the example of FIG. 3, the aerosol-forming substrate has a bulk density of about 500 milligrams per cubic centimetre. As a result, the weight of the aerosol-forming substrate 6 in the example of FIG. 3 is 337 milligrams.

The aerosol-generating article 300 of FIG. 3 has a weight of 515 milligrams. Consequently, with the aerosol-generating article 300 shown in FIG. 3, the ratio of the weight of the downstream section 4 to the weight of the aerosol-forming substrate 6 is 0.44.

FIG. 4 shows an aerosol-generating article 400 having a downstream section 4 and an aerosol-forming substrate section 2. The downstream section 4 is located downstream of the aerosol-forming substrate section 2. In the example of FIG. 4, the aerosol-generating article 400 also includes an upstream section 12 located upstream of the aerosol-forming substrate section 2. The distal end 8 of the aerosol-generating article 400 is defined by an upstream end of the upstream section 12.

The downstream section 4 of the aerosol-generating article 400 shown in FIG. 4 includes one or more tubular elements. In this example, the one or more tubular elements includes a first hollow tubular element 14, a downstream filter segment 16 and a second hollow tubular element 22.

The second hollow tubular element 22 is located immediately downstream of the aerosol-forming substrate section 2. In other words, the first second tubular element 22 abuts the downstream end of the aerosol-forming substrate section 2.

The first hollow tubular element 14 is located immediately downstream of the second hollow tubular element 22. In other words, the first hollow tubular element 14 abuts the downstream end of the second hollow tubular element 22.

The downstream filter segment 16 abuts the downstream end of the first hollow tubular element 14. In other words, the downstream filter segment 16 abuts the downstream end of the first hollow tubular element 14. The downstream end 10 of the aerosol-generating article 400 is defined by a downstream end of the downstream filter segment 16.

In the example of FIG. 4, the length of the aerosol-forming substrate 6 in the aerosol-forming substrate section is about 17 millimetres.

The second hollow tubular element 22 is provided in the form of a hollow cylindrical tube made of cellulose acetate. The second hollow tubular element 22 defines an internal cavity that extends all the way from an upstream end of the second hollow tubular element 22 to a downstream end of the second hollow tubular element 22. The internal cavity is substantially empty, and so substantially unrestricted airflow is enabled along the internal cavity. The second hollow tubular element 22 may not substantially contribute to the overall RTD of the aerosol-generating article 400.

In the example of FIG. 4, the length of the second hollow tubular element 22 is about 8 millimetres and the wall thickness of the second hollow tubular element 22 is about 1.5 millimetres.

The first hollow tubular element 14 is provided in the form of a hollow cylindrical tube made of cardboard or cellulose acetate. The first hollow tubular element 14 defines an internal cavity that extends all the way from an upstream end of the first hollow tubular element 14 to a downstream end of the first hollow tubular element 14. The internal cavity is substantially empty, and so substantially unrestricted airflow is enabled along the internal cavity. The first hollow tubular element 14 may not substantially contribute to the overall RTD of the aerosol-generating article 400.

In the example of FIG. 4, the length of the first hollow tubular element 14 is about 8 millimetres and the wall thickness of the first hollow tubular element 14 is about 1 millimetre.

The downstream filter segment 16 is provided in the form of a cylindrical plug of cellulose acetate tow. In the example of FIG. 4, the length of the downstream filter segment 16 is about 12 millimetres.

The upstream section 12 includes an upstream element 18 abutting the upstream end of the aerosol-forming substrate section 2. The upstream element 18 is provided in the form of a cylindrical plug of cellulose acetate tow. In the example of FIG. 4, the length of the upstream element 18 is about 5 millimetres.

The aerosol-generating article 400 includes a ventilation zone 20 provided at a location along the first hollow tubular element 14. The ventilation zone 20 has at least one circumferential row of perforations extending through the peripheral wall of the first hollow tubular element 14 and a wrapper (not shown) circumscribing the first hollow tubular element 14. In the example of FIG. 4, the ventilation zone 20 is provided at a distance of about 2 millimetres from the downstream end of the first hollow tubular element 14.

The aerosol-generating article 400 has an elongate susceptor element 24 located within the aerosol-forming substrate 6. The susceptor element 24 is arranged substantially longitudinally within the aerosol-forming substrate 6, so as to be approximately parallel to the longitudinal direction of the aerosol-forming substrate 6. As the elongate susceptor element 24 is located in thermal contact with the aerosol-forming substrate 6, the aerosol-forming substrate 6 is heated by the susceptor element 24 when the susceptor element 24 is inductively heated when located within a fluctuating electromagnetic field.

As shown in FIG. 4, the susceptor element 24 is positioned in a radially central position within the aerosol-forming substrate 6 and extends effectively along the longitudinal axis of the aerosol-forming substrate 6. The susceptor element 24 extends all the way from an upstream end to a downstream end of the aerosol-forming substrate 6. In effect, the susceptor element 24 has substantially the same length as the aerosol-forming substrate 6.

The upstream section 12 advantageously prevents the susceptor element 24 from being dislodged from its position within the aerosol-forming substrate 6 and ensures that the consumer cannot accidentally contact the heated susceptor element 24 after use.

The aerosol-generating article 400 of FIG. 4 has a weight of about 513 milligrams.

FIG. 5 shows an aerosol-generating article 500. The aerosol-generating article 500 has a downstream section 4 and an aerosol-forming substrate section 2. The downstream section 4 is located downstream of the aerosol-forming substrate section 2. In the example of FIG. 5, the aerosol-generating article 500 also includes an upstream section 12 located upstream of the aerosol-forming substrate section 2. The distal end 8 of the aerosol-generating article 500 is defined by an upstream end of the upstream section 12.

The downstream section 4 of the aerosol-generating article 500 shown in FIG. 5 includes one or more tubular elements. In this example, the one or more tubular elements includes a first hollow tubular element 14, a downstream filter segment 16 and a second hollow tubular element 22.

The second hollow tubular element 22 is located immediately downstream of the aerosol-forming substrate section 2. In other words, the first second tubular element 22 abuts the downstream end of the aerosol-forming substrate section 2.

The first hollow tubular element 14 is located immediately downstream of the second hollow tubular element 22. In other words, the first hollow tubular element 14 abuts the downstream end of the second hollow tubular element 22.

The downstream filter segment 16 abuts the downstream end of the first hollow tubular element 14. In other words, the downstream filter segment 16 abuts the downstream end of the first hollow tubular element 14. The downstream end 10 of the aerosol-generating article 500 is defined by a downstream end of the downstream filter segment 16.

In the example of FIG. 5, the length of the aerosol-forming substrate 6 in the aerosol-forming substrate section is about 17 millimetres.

The second hollow tubular element 22 is provided in the form of a hollow cylindrical tube made of cellulose acetate. The second hollow tubular element 22 defines an internal cavity that extends all the way from an upstream end of the second hollow tubular element 22 to a downstream end of the second hollow tubular element 22. The internal cavity is substantially empty, and so substantially unrestricted airflow is enabled along the internal cavity. The second hollow tubular element 22 may not substantially contribute to the overall RTD of the aerosol-generating article 500.

In the example of FIG. 5, the length of the second hollow tubular element 22 is about 8 millimetres.

The first hollow tubular element 14 is provided in the form of a hollow cylindrical tube made of cardboard or cellulose acetate. The first hollow tubular element 14 defines an internal cavity that extends all the way from an upstream end of the first hollow tubular element 14 to a downstream end of the first hollow tubular element 14. The internal cavity is substantially empty, and so substantially unrestricted airflow is enabled along the internal cavity. The first hollow tubular element 14 may not substantially contribute to the overall RTD of the aerosol-generating article 500.

In the example of FIG. 5, the length of the first hollow tubular element 14 is about 8 millimetres and the wall thickness of the first hollow tubular element 14 is about 1 millimetre.

The downstream filter segment 16 is provided in the form of a cylindrical plug of cellulose acetate tow. In the example of FIG. 5, the length of the downstream filter segment 16 is about 12 millimetres.

The upstream section 12 includes an upstream element 18 abutting the upstream end of the aerosol-forming substrate section 2. The upstream element 18 is provided in the form of a cylindrical plug of cellulose acetate tow. In the example of FIG. 5, the length of the upstream element 18 is about 5 millimetres.

The aerosol-generating article 500 includes a ventilation zone 20 provided at a location along the first hollow tubular element 14. The ventilation zone 20 has at least one circumferential row of perforations extending through the peripheral wall of the first hollow tubular element 14 and a wrapper (not shown) circumscribing the first hollow tubular element 14. In the example of FIG. 5, the ventilation zone 20 is provided at a distance of about 2 millimetres from the downstream end of the first hollow tubular element 14.

The aerosol-generating article 500 has an elongate susceptor element 24 located within the aerosol-forming substrate 6. The susceptor element 24 is arranged substantially longitudinally within the aerosol-forming substrate 6, so as to be approximately parallel to the longitudinal direction of the aerosol-forming substrate 6. As the elongate susceptor element 24 is located in thermal contact with the aerosol-forming substrate 6, the aerosol-forming substrate 6 is heated by the susceptor element 24 when the susceptor element 24 is inductively heated when located within a fluctuating electromagnetic field.

As shown in FIG. 5, the susceptor element 24 is positioned in a radially central position within the aerosol-forming substrate 6 and extends effectively along the longitudinal axis of the aerosol-forming substrate 6. The susceptor element 24 extends all the way from an upstream end to a downstream end of the aerosol-forming substrate 6. In effect, the susceptor element 24 has substantially the same length as the aerosol-forming substrate 6.

The upstream section 12 advantageously prevents the susceptor element 24 from being dislodged from its position within the aerosol-forming substrate 6 and ensures that the consumer cannot accidentally contact the heated susceptor element 24 after use.

In the example of FIG. 5, the wall thickness of the second hollow tubular element 22 is 1 millimetre. Consequently, the weight of the second hollow tubular element 22 is 47 milligrams. As a result, the weight of the aerosol-generating article 500 is 484 milligrams, and the weight of the downstream section 4 is 157 milligrams.

Decreasing the weight of the second hollow tubular element 22 decreases the weight of the downstream section 4. Consequently, with the aerosol-generating article 400 shown in FIG. 4, the ratio of the weight of the downstream section 4 to the weight of the aerosol-forming substrate 6 is 0.53.

FIG. 6 shows an aerosol-generating article 600. The aerosol-generating article 600 has a downstream section 4 and an aerosol-forming substrate section 2. The downstream section 4 is located downstream of the aerosol-forming substrate section 2. In the example of FIG. 6, the aerosol-generating article 600 also includes an upstream section 12 located upstream of the aerosol-forming substrate section 2. The distal end 8 of the aerosol-generating article 600 is defined by an upstream end of the upstream section 12.

The downstream section 4 of the aerosol-generating article 600 shown in FIG. 6 includes one or more tubular elements. In this example, the one or more tubular elements includes a first hollow tubular element 14, a downstream filter segment 16 and a second hollow tubular element 22.

The second hollow tubular element 22 is located immediately downstream of the aerosol-forming substrate section 2. In other words, the first second tubular element 22 abuts the downstream end of the aerosol-forming substrate section 2.

The first hollow tubular element 14 is located immediately downstream of the second hollow tubular element 22. In other words, the first hollow tubular element 14 abuts the downstream end of the second hollow tubular element 22.

The downstream filter segment 16 abuts the downstream end of the first hollow tubular element 14. In other words, the downstream filter segment 16 abuts the downstream end of the first hollow tubular element 14. The downstream end 10 of the aerosol-generating article 600 is defined by a downstream end of the downstream filter segment 16.

In the example of FIG. 6, the length of the aerosol-forming substrate 6 in the aerosol-forming substrate section is about 17 millimetres.

The second hollow tubular element 22 is provided in the form of a hollow cylindrical tube made of cellulose acetate. The second hollow tubular element 22 defines an internal cavity that extends all the way from an upstream end of the second hollow tubular element 22 to a downstream end of the second hollow tubular element 22. The internal cavity is substantially empty, and so substantially unrestricted airflow is enabled along the internal cavity. The second hollow tubular element 22 may not substantially contribute to the overall RTD of the aerosol-generating article 600.

In the example of FIG. 6, the length of the second hollow tubular element 22 is about 8 millimetres and the wall thickness of the second hollow tubular element 22 is about 1.5 millimetres.

The first hollow tubular element 14 is provided in the form of a hollow cylindrical tube made of cardboard or cellulose acetate. The first hollow tubular element 14 defines an internal cavity that extends all the way from an upstream end of the first hollow tubular element 14 to a downstream end of the first hollow tubular element 14. The internal cavity is substantially empty, and so substantially unrestricted airflow is enabled along the internal cavity. The first hollow tubular element 14 may not substantially contribute to the overall RTD of the aerosol-generating article 600.

In the example of FIG. 6, the length of the first hollow tubular element 14 is about 8 millimetres and the wall thickness of the first hollow tubular element 14 is about 1 millimetre.

The downstream filter segment 16 is provided in the form of a cylindrical plug of cellulose acetate tow. In the example of FIG. 6, the length of the downstream filter segment 16 is about 12 millimetres.

The upstream section 12 includes an upstream element 18 abutting the upstream end of the aerosol-forming substrate section 2. The upstream element 18 is provided in the form of a cylindrical plug of cellulose acetate tow. In the example of FIG. 6, the length of the upstream element 18 is about 5 millimetres.

The aerosol-generating article 600 includes a ventilation zone 20 provided at a location along the first hollow tubular element 14. The ventilation zone 20 has at least one circumferential row of perforations extending through the peripheral wall of the first hollow tubular element 14 and a wrapper (not shown) circumscribing the first hollow tubular element 14. In the example of FIG. 6, the ventilation zone 20 is provided at a distance of about 2 millimetres from the downstream end of the first hollow tubular element 14.

The aerosol-generating article 600 has an elongate susceptor element 24 located within the aerosol-forming substrate 6. The susceptor element 24 is arranged substantially longitudinally within the aerosol-forming substrate 6, so as to be approximately parallel to the longitudinal direction of the aerosol-forming substrate 6. As the elongate susceptor element 24 is located in thermal contact with the aerosol-forming substrate 6, the aerosol-forming substrate 6 is heated by the susceptor element 24 when the susceptor element 24 is inductively heated when located within a fluctuating electromagnetic field.

As shown in FIG. 6, the susceptor element 24 is positioned in a radially central position within the aerosol-forming substrate 6 and extends effectively along the longitudinal axis of the aerosol-forming substrate 6. The susceptor element 24 extends all the way from an upstream end to a downstream end of the aerosol-forming substrate 6. In effect, the susceptor element 24 has substantially the same length as the aerosol-forming substrate 6.

The upstream section 12 advantageously prevents the susceptor element 24 from being dislodged from its position within the aerosol-forming substrate 6 and ensures that the consumer cannot accidentally contact the heated susceptor element 24 after use.

The overall length of the aerosol-generating article 600 is the same as the aerosol-generating article 400 of FIG. 4. However, the length of the aerosol-forming substrate section 2 and the aerosol-forming substrate 6 is increased to 19 millimetres. To allow for the length of the aerosol-forming substrate section 2 to be increased while not increasing the overall length of the aerosol-generating article 600, in the example of FIG. 6, the lengths of the first hollow tubular element 14 and the second hollow tubular element 22 are both lower than in the aerosol-generating article 400 of FIG. 4.

In the aerosol-generating article 600 of FIG. 6, the length of the first hollow tubular element 14 is 7 millimetres and the length of the second hollow tubular element 22 is 7 millimetres.

Decreasing the length of the first hollow tubular element 14 decreases the weight of the first hollow tubular element 14 to 37 milligrams. Decreasing the length of the second hollow tubular element 22 decreases the weight of the second hollow tubular element 22 to 57 milligrams. In the example of FIG. 6, increasing the length of the aerosol-forming section 2 increases the weight of the aerosol-forming substrate 6 to 329 milligrams. As a result, the aerosol-generating article 600 has a weight of 516 milligrams and the downstream section 4 has a weight of 155.25 milligrams.

Increasing the weight of the aerosol-forming substrate 6 while also decreasing the weight of the first hollow tubular element 14 and decreasing the weight second hollow tubular element 22 consequently decreases the ratio of the weight of the downstream section 4 to the weight of the aerosol-forming substrate 6 to 0.47.

FIG. 7 shows an aerosol-generating article 700. The aerosol-generating article 700 has a downstream section 4 and an aerosol-forming substrate section 2. The downstream section 4 is located downstream of the aerosol-forming substrate section 2. In the example of FIG. 7, the aerosol-generating article 700 also includes an upstream section 12 located upstream of the aerosol-forming substrate section 2. The distal end 8 of the aerosol-generating article 700 is defined by an upstream end of the upstream section 12.

The downstream section 4 of the aerosol-generating article 700 shown in FIG. 5 includes one or more tubular elements. In this example, the one or more tubular elements includes a hollow tubular element 14 and a downstream filter segment 16.

The hollow tubular element 14 is located immediately downstream of the aerosol-forming substrate section 2. In other words, the hollow tubular element 14 abuts the downstream end of the aerosol-forming substrate section 2.

The downstream filter segment 16 abuts the downstream end of the hollow tubular element 14. In other words, the downstream filter segment 16 abuts the downstream end of the hollow tubular element 14. The downstream end 10 of the aerosol-generating article 700 is defined by a downstream end of the downstream filter segment 16.

In the example of FIG. 7, the length of the aerosol-forming substrate 6 in the aerosol-forming substrate section is about 17 millimetres.

In the example of FIG. 7, the hollow tubular element 14 has a tubular body defining a cavity 25 extending from a first end 26 of the tubular body to a second end 27 of the tubular body. The hollow tubular element 14 also has a folded end portion forming a first end wall 28 at the first end 26 of the tubular body. The first end wall 28 delimits an opening 29, which permits airflow between the cavity 25 and the exterior of the hollow tubular element 14. In particular, the example of FIG. 7 is configured so that aerosol may flow from the aerosol-forming substrate 6 through the opening 29 into the cavity 25.

In the example of FIG. 7, the cavity 25 is substantially empty, and so substantially unrestricted airflow is enabled along the cavity 25. Consequently, the RTD of the hollow tubular element 14 in FIG. 7 can be localised at a specific longitudinal position of the hollow tubular element 14-namely, at the first end wall 28—and can be controlled through the chosen configuration of the first end wall 28 and its corresponding opening 29. In the example of FIG. 7, the RTD of the hollow tubular element 14 (which is essentially the RTD of the first end wall 28) is substantially 10 millimetres H₂O. In the example of FIG. 7, the hollow tubular element 14 has a length of about 16 millimetres, an external diameter of about 7.1 millimetres, and an internal diameter of about 6.5 millimetres. Thus, a thickness of a peripheral wall of the hollow tubular element is about 0.3 millimetres.

The downstream filter segment 16 is provided in the form of a cylindrical plug of cellulose acetate tow. In the example of FIG. 7, the length of the downstream filter segment 16 is about 12 millimetres.

The upstream section 12 includes an upstream element 18 abutting the upstream end of the aerosol-forming substrate section 2. The upstream element 18 is provided in the form of a cylindrical plug of cellulose acetate tow. In the example of FIG. 7, the length of the upstream element 18 is about 5 millimetres.

The aerosol-generating article 700 includes a ventilation zone 20 provided at a location along the hollow tubular element 14. The ventilation zone 20 has at least one circumferential row of perforations extending through the peripheral wall of the hollow tubular element 14 and a wrapper (not shown) circumscribing the hollow tubular element 14. In the example of FIG. 7, the ventilation zone 20 is provided at a distance of about 2 millimetres from the downstream end of the hollow tubular element 14.

The hollow tubular element 14 of the aerosol-generating article 700 has a weight of 50 milligrams. This results in the aerosol-generating article 700 having a weight of 438 milligrams with the downstream section 4 having a weight of 111.5 milligrams. Consequently, the ratio of the weight of the downstream section 4 to the weight of the aerosol-forming substrate 6 is 0.38. FIG. 8 illustrates an example of an aerosol-generating system 800. The aerosol-generating system 800 includes an exemplary aerosol-generating device 900 and an aerosol-generating article 100, 200, 300, 400, 500, 600, 700 according to any one shown in FIGS. 1 to 7 and described above.

FIG. 8 illustrates a downstream, mouth end portion of the aerosol-generating device 900 where the heating chamber is defined, and the aerosol-generating article can be received. The aerosol-generating device 900 comprises a housing (or body) 30, extending between a mouth end 32 and a distal end (not shown). The housing 30 comprises a peripheral wall 34. The peripheral wall 34 defines a heating chamber for receiving an aerosol-generating article 100, 200, 300, 400, 500, 600, 700. The heating chamber is defined by a closed, distal end and an open, mouth end. The mouth end of the heating chamber is located at the mouth end of the aerosol-generating device 800. The aerosol-generating article 100, 200, 300, 400, 500, 600, 700 is configured to be received through the mouth end of the heating chamber and is configured to abut a closed end of the heating chamber.

A device air flow channel 36 is defined within the peripheral wall 34. The air-flow channel 36 extends between an inlet 38 located at the mouth end of the aerosol-generating device 900 and the closed end of the heating chamber. Air may enter the aerosol-forming substrate 2 via an aperture (not shown) provided at the closed end of the heating chamber, ensuring fluid communication between the air flow channel 36 and the aerosol-forming substrate 2.

The aerosol-generating device 900 also includes a heater (not shown) and a power source (not shown) for supplying power to the heater. A controller (not shown) is also provided to control such supply of power to the heater. The heater is configured to controllably heat the aerosol-generating article 100, 200, 300, 400, 500, 600, 700 during use, when the aerosol-generating article 100, 200, 300, 400, 500, 600, 700 is received within the aerosol-generating device 900. The heater is preferably arranged to externally heat the aerosol-forming substrate 2 of the aerosol-generating article 100, 200, 300, 400, 500, 600, 700 for optimal aerosol generation. The ventilation zone 20 of an aerosol-generating article 100, 200, 300, 400, 500, 600, 700 is arranged to be exposed when the aerosol-generating article 100, 200, 300, 400, 500, 600, 700 is received within the aerosol-generating device 900.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A+10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating article, comprising:
an aerosol-forming substrate section containing an aerosol-forming substrate; and
a downstream section provided at a downstream end of the aerosol-forming substrate section, the downstream section comprising one or more hollow tubular elements, the downstream section further comprising a downstream filter segment, and the downstream section having a length of at least 25 millimetres,
wherein a ratio of a weight of the downstream section to a weight of the aerosol-forming substrate is less than or equal to 1.

17. The aerosol-generating article according to claim 16, wherein the ratio of the weight of the downstream section to the weight of the aerosol-forming substrate is less than or equal to 0.9.

18. The aerosol-generating article according to claim 16, wherein the ratio of the weight of the downstream section to the weight of the aerosol-forming substrate is less than or equal to 0.85.

19. The aerosol-generating article according to claim 16, wherein the ratio of the weight of the downstream section to the weight of the aerosol-forming substrate is less than or equal to 0.8.

20. The aerosol-generating article according to claim 16, wherein the length of the downstream section is less than or equal to 40 millimetres.

21. The aerosol-generating article according to claim 16, wherein the downstream section has a resistance to draw (RTD) of less than 20 mm H₂O.

22. The aerosol-generating article according to claim 16, further comprising an upstream section provided at an upstream end of the aerosol-forming substrate section, the upstream section comprising an upstream element.

23. The aerosol-generating article according to claim 22, wherein the upstream element is formed of a hollow tubular segment defining a longitudinal cavity providing an unrestricted flow channel.

24. The aerosol-generating article according to claim 22, wherein the upstream element has a weight of less than or equal to 70 milligrams.

25. The aerosol-generating article according to claim 16,
further comprising one or more susceptor elements,
wherein the one or more susceptor elements are provided in the aerosol-forming substrate section.

26. The aerosol-generating article according to claim 16, wherein the aerosol-forming substrate section has a length of at least 8 millimetres.

27. The aerosol-generating article according to claim 16, wherein the aerosol-forming substrate comprises one or more aerosol formers.

28. The aerosol-generating article according to claim 16, wherein the aerosol-forming substrate has an aerosol former content of at least 10 percent by weight, on a dry weight basis.

29. The aerosol-generating article according to claim 16, wherein a ratio of a length of the aerosol-forming substrate section to a length of the aerosol-generating article is at least 0.3.

30. An aerosol-generating system, comprising:
an aerosol-generating article according to claim 16; and
an aerosol-generating device comprising:
a heating chamber configured to receive the aerosol-generating article, and
at least a heating element provided at or about a periphery of the heating chamber.
